(19) United States
(12) Patent Application Publication
(10) Pub. No.: US 2024/0249380 A1
(43) Pub. Date: Jul. 25, 2024

(54) OBJECT RESIZING METHOD, COMPUTER READABLE STRAGE MEDIUM, AND INFORMATION PROCESSING APPARATUS

(71) Applicant: CANON KABUSHIKI KAISHA, Tokyo (JP)

(72) Inventor: YOSHINORI HASHIMOTO, Tokyo (JP)

(21) Appl. No.: 18/411,518

(22) Filed: Jan. 12, 2024

(30) Foreign Application Priority Data
Jan. 23, 2023 (JP) 2023-008041

(51) Int. Cl. G06T 3/40; G06F 3/04845

(52) U.S. Cl. CPC G06T 3/40; G06F 3/04845

(57) ABSTRACT

Provided is a non-transitory computer readable storage medium on which a computer program is recorded, the computer program, when executed, causing a computer to perform an object resizing method including receiving an input for simultaneously changing the sizes of a plurality of objects linked to one another in an edit region on a screen and changing the sizes of the plurality of objects simultaneously in response to the input while changing the sizes of the plurality of objects based on reference points provided to the respective objects.

### BACKGROUND OF THE DISCLOSURE

### Field of the Disclosure

The present disclosure relates to an object resizing method for resizing an object such as an image or text, a non-transitory computer readable storage medium, and an information processing apparatus.

### Description of the Related Art

For layout software that designs the arrangement of objects such as images and text on an edit region on a screen, a technique for resizing the objects arranged is known. Examples of such an object resizing method include a method of scaling up or down a target object using a point at an end portion of the target object as a reference point and a method of scaling up or down a target object using a center point of the target object as a reference point. This enables a user to achieve an intended content design through size adjustment of objects.

In this regard, unless the reference point used to resize the object is set appropriately, the object may move to a position that ruins the layout of the contents. Then, a user needs to correct the position of the object, which may lower the usability. Japanese Patent Laid-Open No. 2021-136550 (hereinafter referred to as Literature 1) discloses a technique where, in resizing of a cachet image, a resize reference point is switched depending on whether the cachet image is located at the end of text. The technique disclosed in Literature 1 improves usability with this switching, but it is effective only for particular layouts.

### SUMMARY OF THE DISCLOSURE

The present disclosure provides a non-transitory computer readable storage medium on which a computer program is recorded, the computer program, when executed, causing a computer to perform an object resizing method including receiving an input for simultaneously changing sizes of a plurality of objects linked to one another in an edit region on a screen and changing the sizes of the plurality of objects simultaneously in response to the input while changing the sizes of the plurality of objects based on reference points provided to the respective objects.

Further features of the present disclosure will become apparent from the following description of exemplary embodiments with reference to the attached drawings.

### BRIEF DESCRIPTION OF THE DRAWINGS

FIG. 1 is a block diagram showing a system configuration;

FIG. 2 is a flowchart showing processing performed by a poster editing application;

FIG. 3 is a diagram showing an application;

FIG. 4 is a diagram showing a preferences screen;

FIG. 5 is a flowchart showing processing in a first embodiment;

FIGS. 6A and 6B are diagrams showing an edit region in the first embodiment;

FIGS. 7A and 7B are diagrams showing an edit region in the first embodiment;

FIGS. 8A and 8B are diagrams showing an edit region in the first embodiment;

FIGS. 9A and 9B are diagrams showing an edit region in the first embodiment;

FIG. 10 is a flowchart showing processing in a second embodiment;

FIGS. 11A and 11B are diagrams showing an edit region in the second embodiment;

FIGS. 12A and 12B are diagrams showing an edit region in the second embodiment;

FIGS. 13A and 13B are diagrams showing an edit region in the second embodiment;

FIGS. 14A and 14B are diagrams showing an edit region in the second embodiment;

FIGS. 15A and 15B are diagrams showing an edit region in the second embodiment;

FIGS. 16A and 16B are diagrams showing an edit region in the second embodiment;

FIGS. 17A and 17B are diagrams showing an edit region in the second embodiment;

FIGS. 18A and 18B are diagrams showing an edit region in the second embodiment;

FIG. 19 is a flowchart showing processing in a third embodiment;

FIGS. 20A and 20B are diagrams showing an edit region in the third embodiment;

FIG. 21 is a diagram showing an edit region in the third embodiment;

FIG. 22 is a flowchart showing processing in a fourth embodiment;

FIGS. 23A and 23B are diagrams showing an edit region in the fourth embodiment;

FIGS. 24A and 24B are diagrams showing an edit region in the fourth embodiment;

FIGS. 25A and 25B are diagrams showing an edit region in the fourth embodiment; and

FIGS. 26A and 26B are diagrams showing an edit region in the fourth embodiment;

### DESCRIPTION OF THE EMBODIMENTS

Embodiments of the present disclosure are described below with reference to the drawings attached hereto. Note that the present disclosure can be applied to all kinds of layout software such as an object layout application, a poster editing application, a photo album editing application, and presentation creating software. The embodiments of the present disclosure are described using a poster editing application (a web application) as an example.

### First Embodiment

### Information Processing System

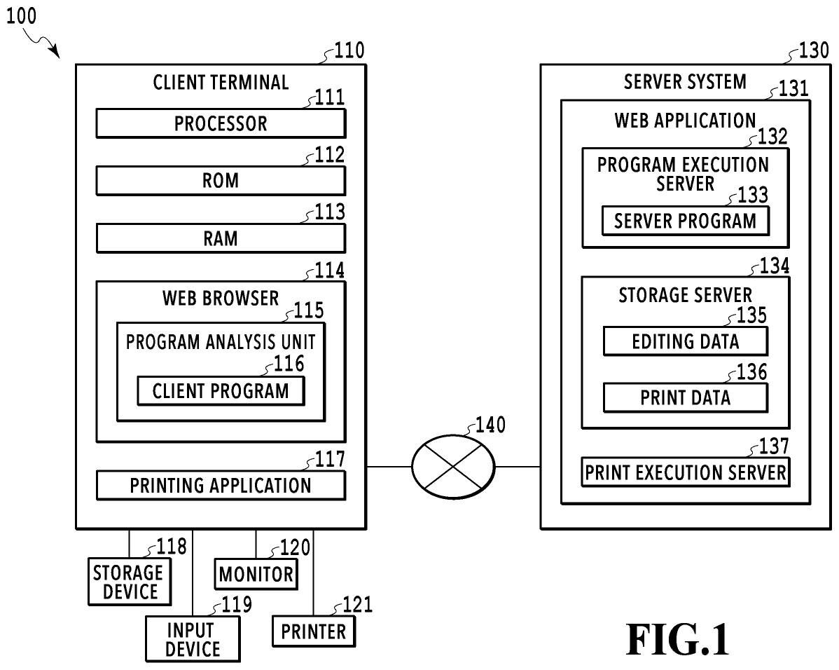

FIG. 1 shows a configuration diagram of an information processing system 100 according to a technique of the present disclosure. The information processing system 100 operates through cooperation between a client terminal 110 and a server system 130 via a network 140.

First, the configuration of the server system 130 used in the technique of the present disclosure is described. The server system 130 performs server processing for a web application 131 and includes a program execution server 132, a storage server 134, and a printing execution server 137. The program execution server 132 executes server programs 133 which are programs that operate on the server system 130. The storage server 134 stores editing data 135 and print data 136, such as image files for the web application and print data files. The printing execution server 137 transmits the print data 136 to a printing application 117 to perform printing. Note that the program execution server 132, the storage server 134, and the printing execution server 137 may be implemented by physically separate apparatuses or may be implemented by a single apparatus.

Next, the configuration of the client terminal 110 used in the technique of the present disclosure is described. The client terminal 110 is an information processing apparatus and is formed by, for example, a typical personal computer or a smartphone. The client terminal 110 includes a processor 111, a ROM 112, and a RAM 113. The client terminal 110 also includes an input/output interface (not shown) for connecting to a storage device 118, an input device 119, a monitor 120, a printer 121, and the network 140 such as the Internet. The processor 111 is a central processing unit and performs overall control of the client terminal 110 by executing an operating system stored in the storage device 118, the ROM 112, or the RAM 113. Also, by executing a web browser 114, the printing application 117, and other programs, the processor 111 performs computation based on inputted data to process and output the data and to control hardware components. The processor 111 thus implements the functions of the client terminal 110. The web browser 114, the printing application 117, and other programs are stored in the ROM 112 or the RAM 113. The ROM 112 is a read-only memory and stores programs. The RAM 113 is a random-access memory used by the processor 111 as its work memory, but is also capable of storing programs in a case where the RAM is non-volatile. The web browser 114 enables browsing of web sites on the Internet and executes the web application 131. To execute the web application 131, a client program 116 is received from the server system 130 and is executed by a program analysis unit 115 that interprets a scripting language such as HTML or JavaScript. The printing application 117 transmits the print data 136 to the printer 121 connected to the client terminal 110 directly or via the network 140 to perform printing.

The printer 121 executes printing based on print data created by the information processing system 100. The storage device 118 is a storage device for storing image data, templates, and the like and is, e.g., an HDD or an SSD. The input device 119 is an input device for inputting information to the information processing system 100 and is, e.g., a keyboard or a pointing device. Depending on its form, the input device may be integral with a motor as a touch panel which receives an input through a direct touch on the monitor. The monitor 120 is a display device for displaying image information outputted from the information processing system 100. Note that the configuration shown in FIG. 1 is an example, and a different mode may be employed. For example, the client terminal 110 may be configured including the storage device 118, the input device 119, and the monitor 120.

### Poster Editing Application

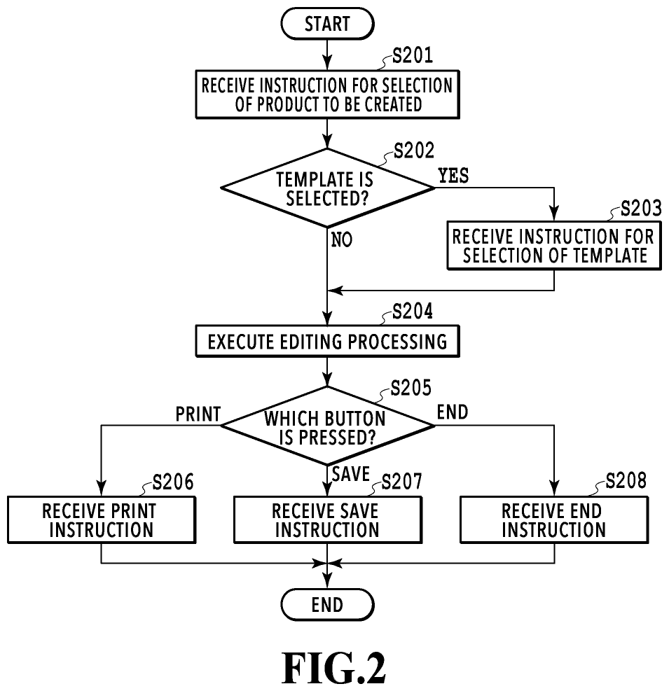

Next, using FIGS. 2 to 4, a description is given of processing performed by a poster editing application of the present embodiment.

Processing in FIG. 2 is started once a user activates a poster editing application 131 which is a web application. Note that each step in FIG. 2 is implemented by the processor 111 by reading a program related to the processing in the flowchart from memory and executing the program.

First, in Step S201, the processor 111 receives a user instruction for selection of a product to be created and sets the type of the product to be created (such as a poster, a flier, or a calendar) based on a user operation. Hereinbelow, “Step S###” is referred to simply as “S###.”

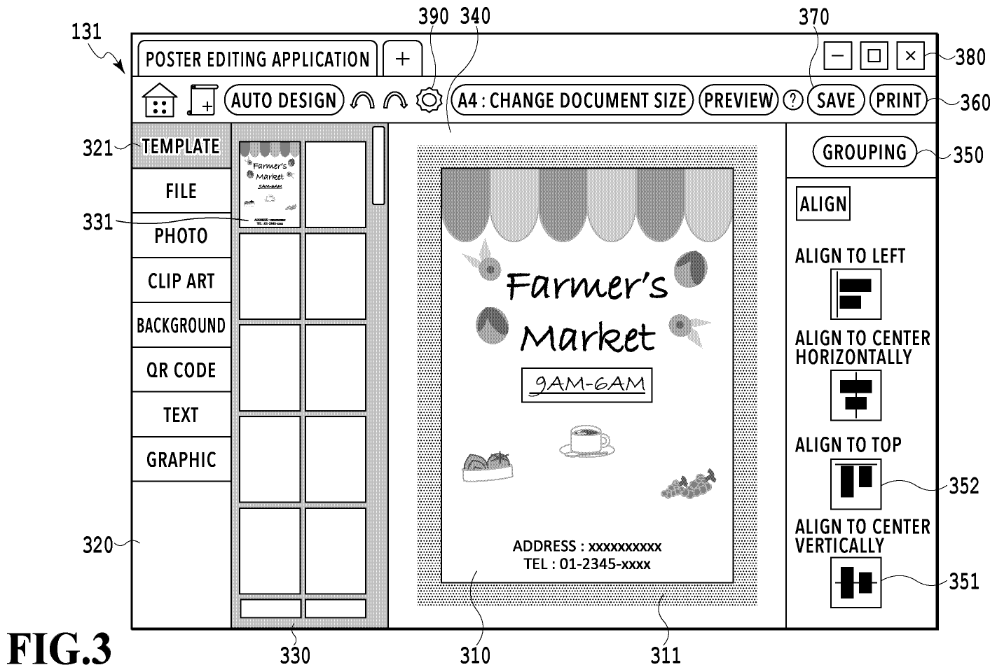

In S202, based on a user operation on the poster editing application 131 in FIG. 3, the processor 111 determines whether a template has been selected. Once the user selects a template selection button 321 in a category selection region 320, the processor 111 displays a list of templates in a template selection region 330. If the user selects a template in this region, the result of the determination in S202 is YES, and the processing proceeds to S203.

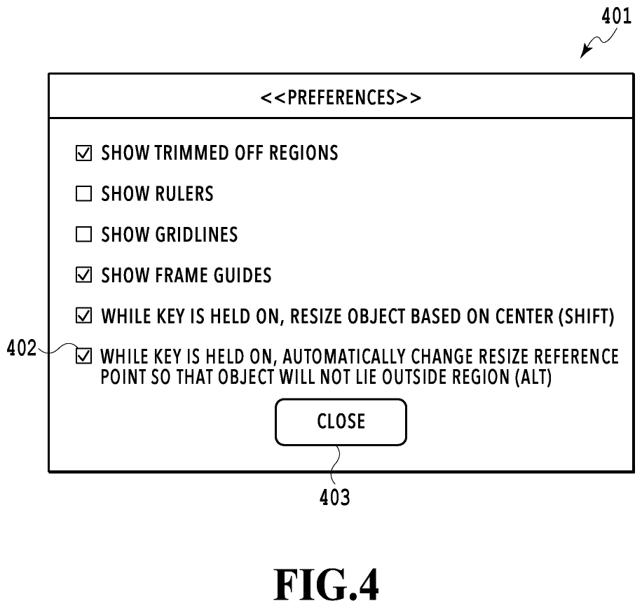

In S203, the processor 111 receives an instruction for selection of a template, and displays poster data on the selected template in a poster region 310. The poster region 310 is a region included in an edit region 340. FIG. 3 shows an example of a case where a user selects a template 331 in the template selection region 330. Note that the region surrounding the poster region 310 is a trim region 311 trimmed off in printing to align the edges of paper, and a user can use the trim region 311 as a guideline for object layout in performing borderless printing. The trim region 311 around the edit region 340 may be set to be hidden, and the setting can be changed to suit the preferences of the user on a preferences screen 401 in FIG. 4 displayed upon pressing of a preferences button 390 in FIG. 3. Once the processing in S203 is complete or the result of the determination in S202 is NO, the processor 111 proceeds to S204.

In S204, the processor 111 executes editing processing based on user operations, reflects the editing in the poster data, and displays the resultant poster data in the poster region 310 included in the edit region 340. Specific examples of an editing operation include adding an object, placing an object, resizing an object, and grouping a plurality of objects. After completion of the processing in S204, the processor 111 proceeds to S205.

Note that the poster editing application 131 has a preferences setting function by which a user can switch between editing view options to suit the user's preferences. Examples of a view option include a setting whether to show the trim region 311 and a setting whether to show gridlines or guides in the edit region 340 that can serve as a guideline for arrangement. The preferences button 390 is used to switch the editing view options to suit the user preferences. Upon receipt of pressing of the preferences button 390, the processor 111 displays the preferences screen 401 shown in FIG. 4 in place of (or in addition to) the edit region 340. Each of the checkboxes on the preferences screen 401 receives a user selection. Also, once a user presses a close button 403 after configuring settings on the preferences screen 401, the processor 111 receives the user input, and the edit region 340 is shown again. Note that the items that can be switched on the preferences screen 401 are not limited to the ones shown in FIG. 4, and the items can be changed depending on the type of the application.

In S205, based on a user operation, the processor 111 determines which button has been pressed. If PRINT is the result of the determination in this step, i.e., if pressing of a print button 360 is detected, the processing proceeds to S206 where the processor 111 receives a print instruction and transmits the poster data to the printing application 117. Meanwhile, if SAVE is the result of the determination in this step, i.e., if pressing of a save button 370 is detected, the processing proceeds to S207 where the processor 111 executes poster data saving processing. Also, if END is the result of the determination in this step, i.e., if pressing of an end button 380 is detected, the processing proceeds to S208 where the processor 111 receives an instruction to end the application.

Once processing in any one of S206, S207, and S208 is completed, the processor 111 receives an instruction to end the poster editing processing, and the series of processes is thus completed. The above is an outline of the processing performed by the poster editing application.

### Changing the Reference Point During Resizing Processing According to the Layout

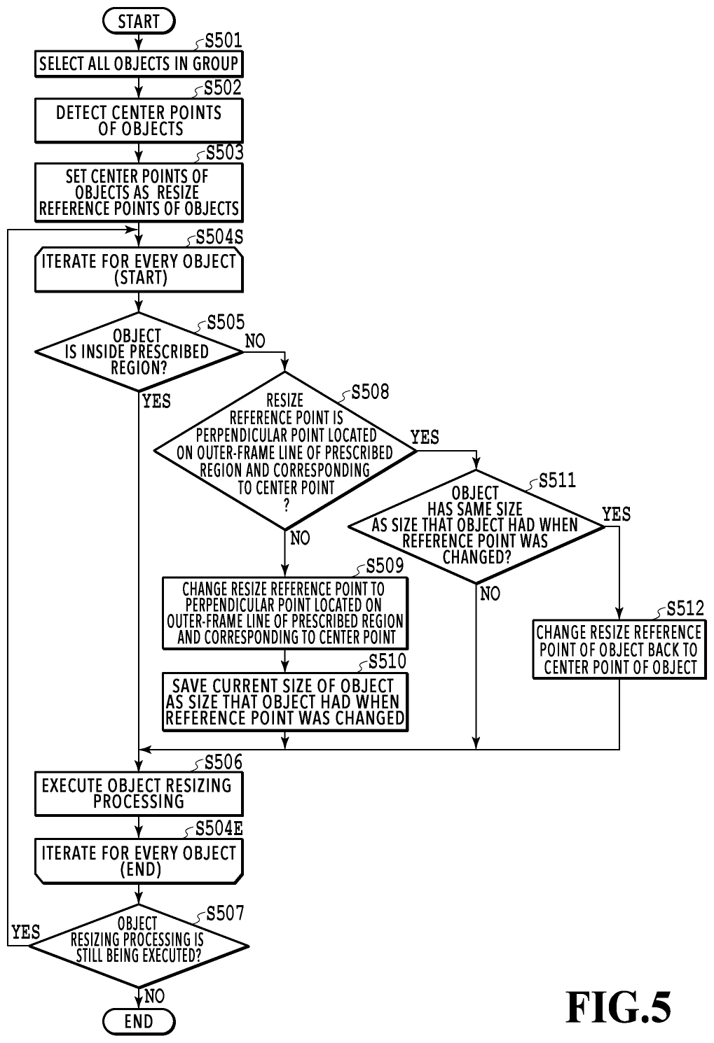

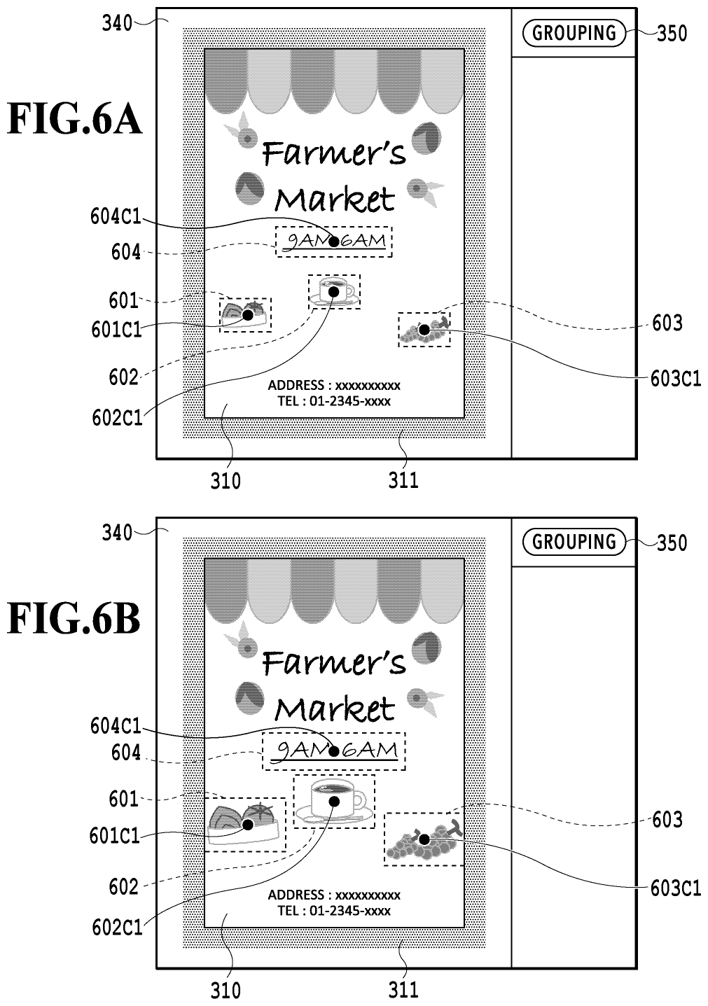

Next, using FIGS. 5 to 9B, a description is given of changing a reference point during resizing processing according to the layout, which is a characteristic of the present embodiment. In the present embodiment, during the object resizing processing performed by a user, the resize reference point is changed, and the object size changing is continued using the changed reference point. FIG. 5 is a flowchart showing the processing in the present embodiment, and FIGS. 6A to 9B show how the edit region changes during the resizing processing.

As an example, the present embodiment describes a case where objects 601 to 604 are resized among the objects arranged in the poster edit region 340, as shown in FIG. 6A. The four objects 601 to 604 in the edit region 340 are linked to one another by being grouped using a grouping button 350. Upon execution of the resizing processing, the plurality of objects 601 to 604 linked to one another by grouping are resized simultaneously. Note that the plurality of objects 601 to 604 linked to one another are assigned link identification information which is common to these objects and is for uniquely identifying their group.

Processing in FIG. 5 is started upon detection of a user operation for object resizing processing. Here, the resizing processing is started once the pointing device selects a resize handle (not shown) located at a rectangular outer frame (not shown) of the group, and is ended once the selection is canceled. All the objects belonging to the group are resized in the event where the handle is moved using the pointing device between the start and end of the resizing processing, i.e., during continuance of resizing. Also, in a case where a touch panel integrally having the input device 119 and the monitor 120 is used, the rectangular outer frame of the group may be scaled down or scaled up by a pinch-in or pinch-out operation performed by the fingers of the user.

In S501, the processor 111 detects objects belonging to the group selected in the edit region 340. In other words, the processor 111 detects all the objects belonging to the group targeted for resizing. For example, the objects 601 to 604 in FIG. 6A are detected in the present embodiment. Note that this step is not always necessarily executed after the detection of an operation for the resizing processing, and may be executed beforehand.

Next, in S502, the processor 111 detects the center points of the respective objects 601 to 604. The center points of the objects 601 to 604 are detected as 601C1 to 604C1 as shown in FIG. 6A. The center point of an object is, for example, the center point of a rectangular outer frame of the object, as shown in FIG. 6A.

Next, in S503, the processor 111 sets the center point of each object as a resize reference point for the object. Specifically, for the objects 601 to 604, the center points 601C1 to 604C1 of the objects are set as their respective resize reference points, as shown in FIG. 6A.

Now, an outline of the processing performed after this is described.

In each of the iterations for the respective objects, if it is determined that the object is not inside a prescribed region (NO in S505), processing for changing the resize reference point and processing for changing it back are executed in S508 to S512. Specifically, processing for changing the resize reference point is executed in S509, and processing for changing the resize reference point back is executed in S512. Then, in each iteration, resizing processing is always executed in S506.

After the processing from S504S to S504E is completed for all the objects belonging to the group, it is determined in S507 whether the object resizing operation is continuing. If the operation is continuing, the processing from S504S to S504E is executed again.

In each of the iterations for the respective objects, if it is determined in S505 that the object is not inside the prescribed region (NO), the processing proceeds to the determination in S508. Then, if it is determined in S508 that the resize reference point has not been changed (NO), the resize reference point is changed in S509. Meanwhile, if it is determined in S508 that the resize reference point has been changed (YES), the processing proceeds to the determination in S511. If it is determined in S511 that the object has been resized back to the size that the object had when its reference point was changed (YES), in S512, the resize reference point is changed back. Thus, in a case where after the resize reference point is changed, the object is resized back to the size that the object had when the reference point was changed, the resize reference point is changed back.

Back to the specific description of the processing shown in FIG. 5, after S503, the processor 111 repeats the steps between S504S to S504E for all the objects in the group.

In each iteration, first, in S505, the processor 111 determines whether the object targeted for the processing in the current iteration (one of the objects 601 to 604) is inside a prescribed region. In the description of the present embodiment, it is assumed that the prescribed region is the poster region 310. Note that the prescribed region is not limited to the poster region, and in other examples, may be the trim region 311 or a region surrounded by gridlines serving as guidelines for arrangement.

If the result of the determination in S505 is YES, i.e., if the region surrounded by the rectangular outer frame of the object is entirely inside the prescribed region, the processor 111 proceeds to S506. In S506, the processor 111 executes the object resizing processing.

If the result of the determination in S505 is NO, i.e., if one of the four outer-frame lines forming the rectangular outer frame of the object overlaps with one of the four outer-frame lines forming the prescribed region, the processor 111 proceeds to the determination processing in S508. Note that because of the processing in S509 to be described later, a situation is avoided where part of the region surrounded by the rectangular outer frame of the object lies beyond the prescribed region.

In S508, the processor 111 determines whether the resize reference point of the object has been changed to a perpendicular point belonging to the outer-frame line of the prescribed region and corresponding to the center point of the object. A perpendicular point belonging to the outer-frame line of the prescribed region and corresponding to the center point of the object is a point where a perpendicular drawn from the center point of the object to the outer-frame line of the prescribe region intersects with the outer-frame line. In other words, in S508, the processor 111 determines whether changing the reference point during the resizing processing, which is one of the characteristics of the present disclosure, is currently being applied. If the result of the determination in S508 is NO, i.e., if the change of the reference point during the resizing processing is not being currently applied, the processor 111 proceeds to S509.

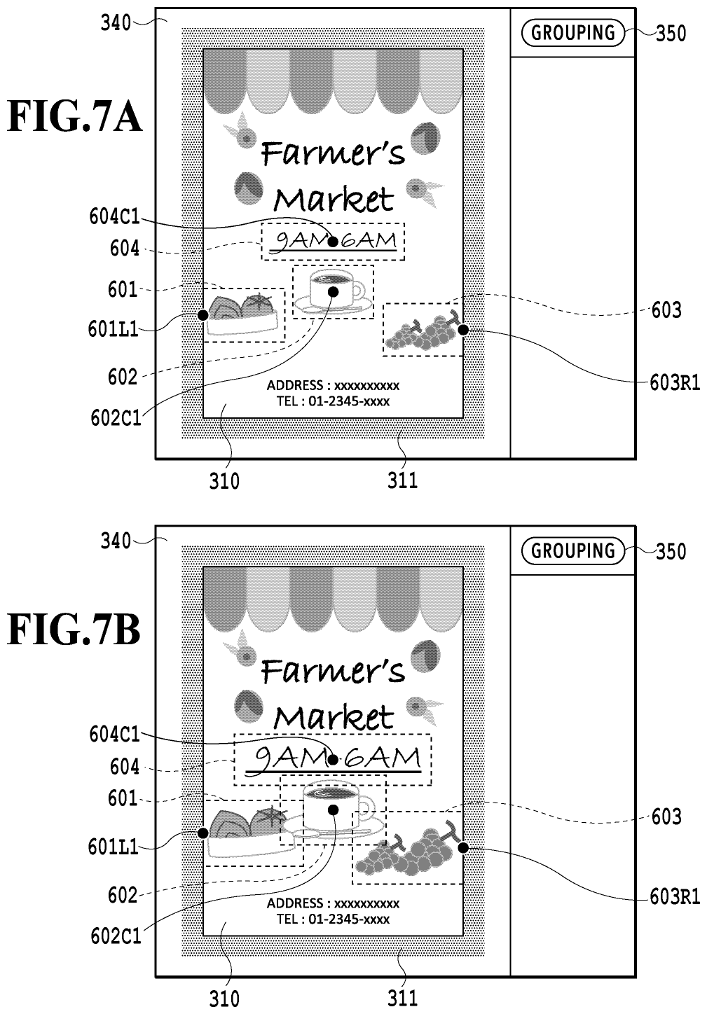

In S509, the processor 111 changes the resize reference point of the target object to the perpendicular point belonging to the outer-frame line of the prescribed region and corresponding to the center point of the object. The outer-frame line of the prescribed region here is one of the four outer-frame lines forming the prescribed region which overlaps with an outer-frame line of the object. This perpendicular point also belongs to one of the four outer-frame lines of the object which overlaps with the outer-frame line of the prescribed region. For instance, for the objects 601 and 603, perpendicular points 601L1 and 603R1 are set as new resize reference points, as shown in FIG. 7A.

The processor 111 proceeds from S509 to S510 where the processor 111 saves the size that the object had when the reference point was changed in S509 (i.e., the current size of the object) so that it can be referred to in S511 to be executed later, and proceeds to S506.

If the result of the determination in S508 is YES, i.e., if changing the reference point during the resizing processing is currently being applied, the processor 111 proceeds to S511 where the processor 111 determines whether the current size of the object is the same as the size that the object had when the reference point was changed. In this step, the size of the object saved in S510 executed last is referred to. If the object is resized after the reference point was changed, the determination in S511 is NO, but if the size of the object is changed back, the determination in S511 is YES.

The processor 111 proceeds straight to S506 if the determination in S511 is NO. Meanwhile, if it is determined YES in S511, in S512, the processor 111 changes the resize reference point back to the center point of the object and then proceeds to S506. In other words, the processor 111 proceeds to S506 after restoring the pre-change reference point in S512.

After repeating the processing from S504S to S504E for every object, the processor 111 determines in S507 whether the object resizing processing is still being executed. For example, the processing is still being executed in a case where the group resizing operation is continuing. To give a more specific example, the processing is still being executed in a case where, for example, the handle for group resizing is still being selected by the pointing device. If the result of the determination in S507 is YES, the processor 111 executes the iteration process from S504S to S504E again. If the result of the determination in S507 is NO, the processor 111 ends the resizing processing.

Thus, iterating S504S to S504E for all of the objects belonging to the group means that S506 is executed on all the objects and therefore all the objects have been resized simultaneously. Also, repeating the iteration from S504S to S504E until the result of the determination in S507 is NO means that S506 is executed a plurality of times on all the objects. Consequently, all the objects have been resized simultaneously.

In the example shown in FIG. 6A, link identification information is assigned to the objects 601 to 604. With a scale-up operation, as shown in FIG. 6B, the objects 601 to 604 are scaled up based on their respective center points 601C1 to 604C1. In the example shown in FIG. 6B, the objects 601 to 603, which are graphics, are scaled up, and the object 604, which is text, is scaled up. In the example shown in FIG. 6B, the left frame line of the object 601 overlaps with the left frame line of the prescribed region, and the right frame line of the object 603 overlaps with the right frame line of the prescribed region. In this case, for the objects 601 and 603, the result of the determination in S505 is NO, and the result of the determination in S508 is also NO. Thus, in S509, as shown in FIG. 7A, the resize reference point of the object 601 is changed from the center point 601C1 to the perpendicular point 601L1, and the resize reference point of the object 603 is changed from the center point 603C1 to the perpendicular point 603R1. For the objects 602 and 604, because they are inside the prescribed region, the determination in S505 is YES, and the center points 602C1 and 604C1 stay to be their respective resize reference points.

In a case where an operation for a further size-up is continued on the group, the objects 601 to 604 are scaled up as shown in, for example, FIG. 7B. In the example shown in FIG. 7B, compared to the arrangement shown in FIG. 7A, the object 601 is scaled up based on the perpendicular point 601L1, maintaining the horizontal position of the left frame line, and the object 603 is scaled up based on the perpendicular point 603R1, maintaining the horizontal position of the right frame line. The objects 602 and 604 are enlarged maintaining the positions of the center points 602C1 and 604C1, respectively.

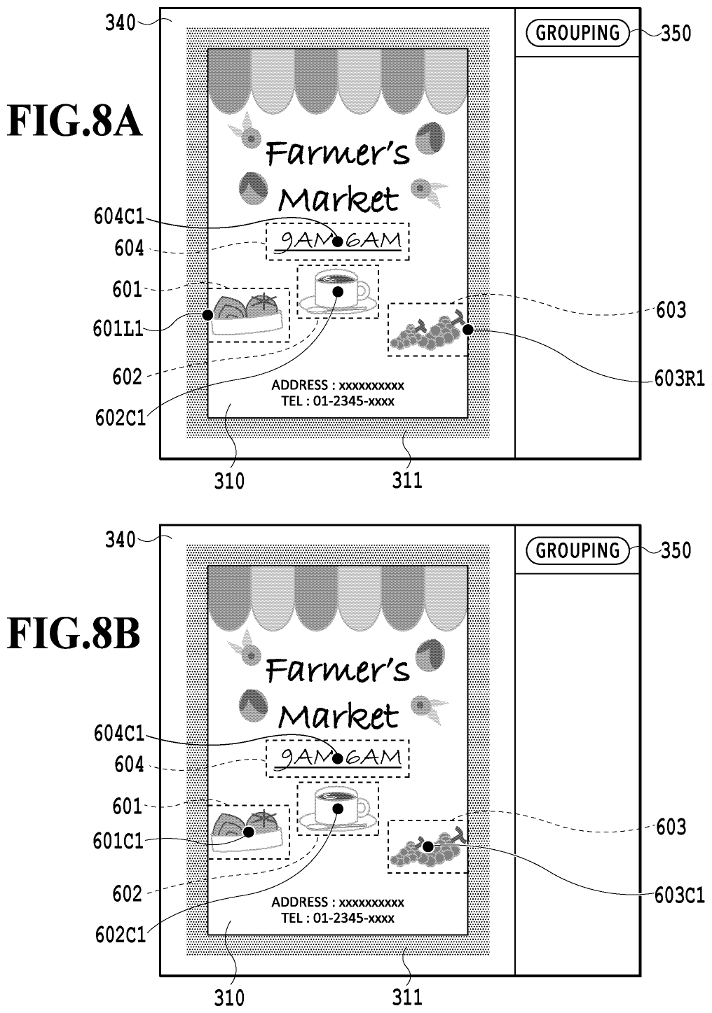

In a case where a size-down operation is performed on the group after that, as shown in FIG. 8A, the objects 601 to 604 may be resized back to the sizes that the objects 601 and 603 had when their respective resize reference points were changed. In this case, for the objects 601 and 603, the determination result in S505 is NO, the determination result in S508 is YES, and the determination result in S511 is YES. Thus, S512 is executed on the objects 601 and 603, and as shown in FIG. 8B, the resize reference points of the objects 601 and 603 are changed back to the center points 601C1 and 603C1. Note that the resize reference points of the objects 602 and 604 are still the center points 602C1 and 604C1.

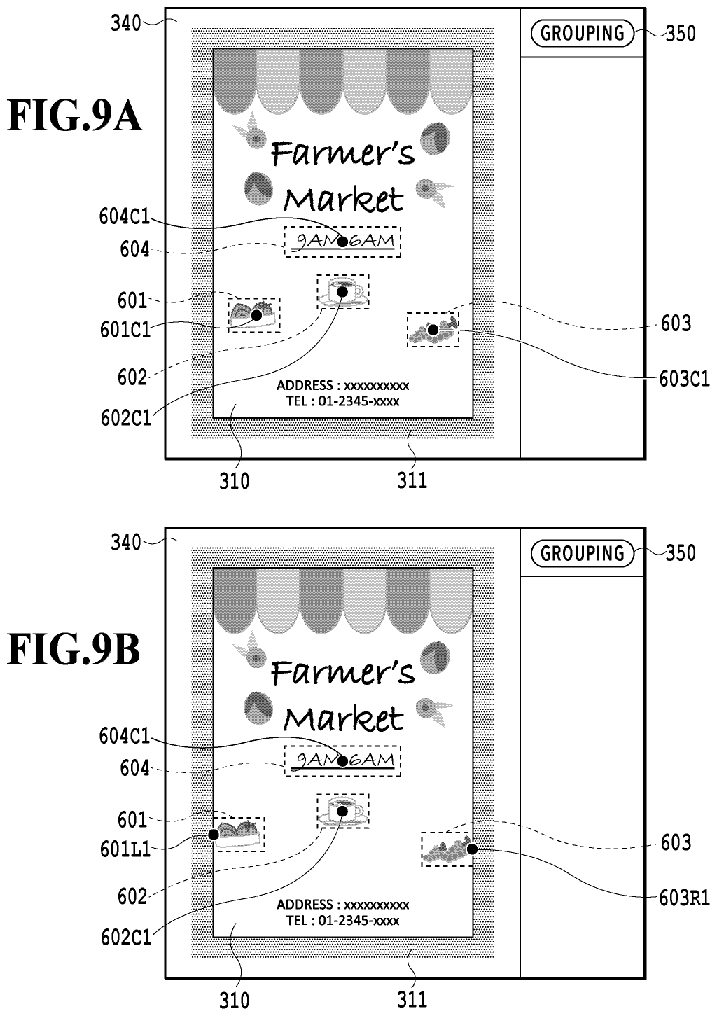

In a case where a size-down operation is further performed on the group, the objects 601 to 604 look as shown in FIG. 9A. In the example shown in FIG. 9A, compared to the arrangement shown in FIG. 8B, the objects 601 to 604 are scaled down based on the center points 601C1 to 604C4, respectively.

In the example described above, in a case where the objects 601 to 604 are resized back to the sizes that the objects 601 and 603 had when their respective resize reference points were changed as shown in FIG. 8A, the resize reference points are changed back as shown in Fig, 8B. However, it is not always needed that the resize reference points are changed back. That is, the resize reference points may be kept in such a case. In a case where a size-down operation is further performed on the group while keeping the changed resize reference points, the objects 601 to 604 look as shown in FIG. 9B. In the example shown in FIG. 9B, based on the arrangement shown in FIG. 8A, the objects 601 and 603 are scaled down based on the perpendicular points 601L1 and 603R1, respectively. Also, the objects 602 and 604 are reduced based on the center points 602C1 and 604C1, respectively.

Although a plurality of objects that are grouped using the grouping button 350 are targeted in the present embodiment as an example of a plurality of objects linked to one another, it is to be noted that the present disclosure is not limited to this description. For example, in a case where a plurality of objects are arrayed on the same reference line by object snapping or the like, the processing of the present embodiment may be executed on these objects as the plurality of objects linked to one another. Also, the processing of the present embodiment may be executed on a plurality of objects currently being selected by a user operation, as the plurality objects linked to one another. Further, the present disclosure is not limited to a plurality of objects linked to one another and may be applied to a single object, as will be described as a fourth embodiment.

Also, the present function can be implemented in combination with a key operation. For example, using a checkbox 402 on the above-described preferences screen 401 shown in FIG. 4, a setting can be configured so as to use a key operation in combination, so that the reference point may be automatically switched during resizing processing only while the “ALT” key is held on. Also, similarly, in resizing a plurality of objects, it is also possible to change each object based on the center of the object only while the “SHIFT” key is held on. In that case, in a case where the “SHIFT” key is not held on in resizing of a plurality of objects, the plurality of objects may be resized simultaneously so as to maintain the similarity or congruence of the arrangement of the plurality of objects in a rectangular outer frame. In particular, the plurality of objects may be resized simultaneously based on the center of the rectangular outer frame containing the plurality of objects.

### Advantageous Effects of the Present Embodiment

As described above, in the present embodiment, in simultaneous resizing of a plurality of objects linked to one another by grouping, the center points of the objects are set as the resize reference points of the objects. Then, during the resizing processing, the resize reference points are changed according to the layout so that the objects may not be placed outside the prescribed region. This makes it possible to improve useability for a user in performing layout operations and also enables the user to easily create a layout with an excellent design without objects being partly or entirely placed outside the prescribed region in printing or displaying a presentation slide.

### Second Embodiment

Next, a second embodiment is described. The present embodiment differs from the first embodiment in the initial reference point for object resizing. Specifically, in the first embodiment, resizing processing is performed on each object belonging to a group using the center point of each object as the initial reference point. By contrast, the present embodiment performs resizing processing on each of a plurality of objects by setting the initial reference point of each object to a point belonging to a reference line used for positional alignment of the plurality of objects. Note that where appropriate, the following description omits descriptions of the same configurations as those in the first embodiment by using the same reference numerals or the same names as those used in the first embodiment.

### Changing the Reference Point During Resizing Processing According to the Layout

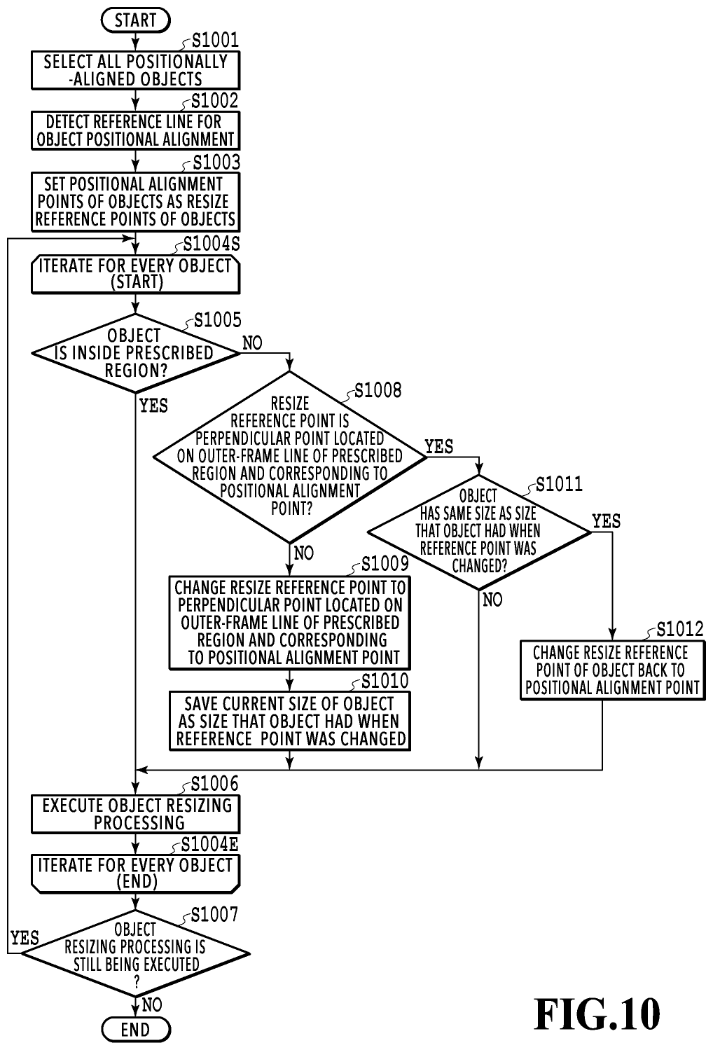

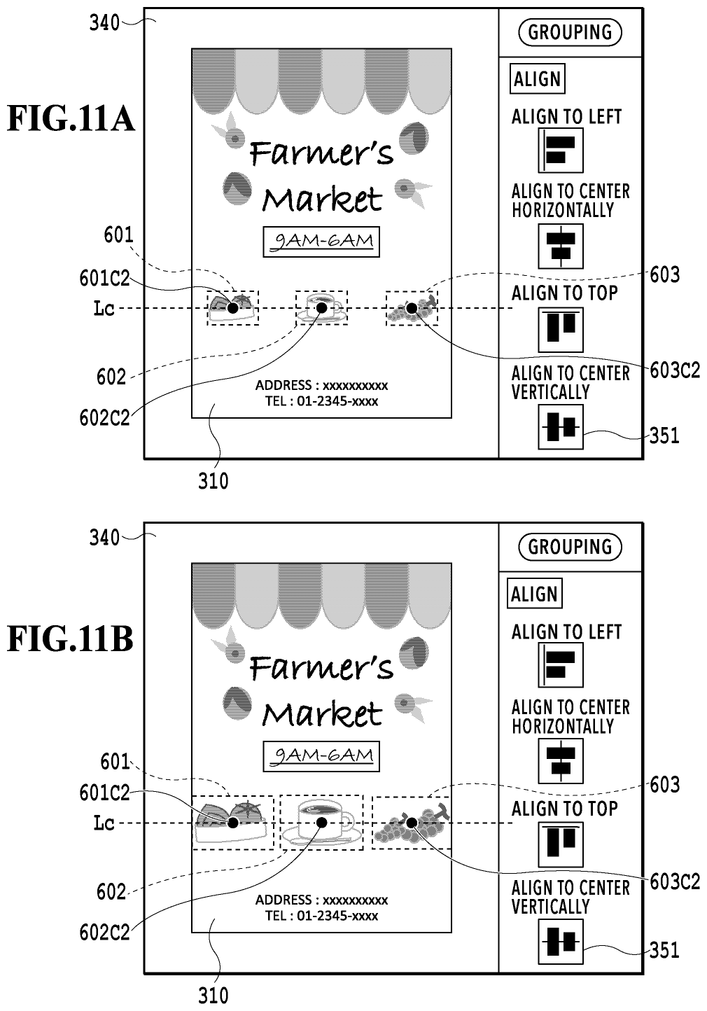

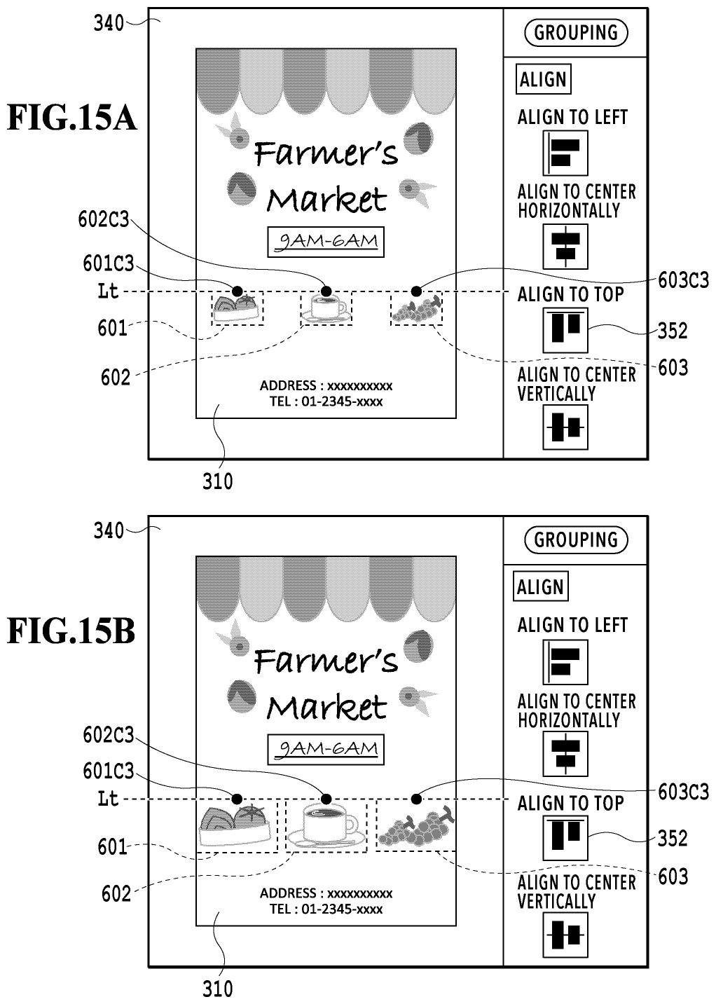

Using FIGS. 10 to 18, the following describes displaying arrangement candidates in the present embodiment. FIG. 10 is a flowchart showing processing of the present embodiment, FIGS. 11A to 14B show how the edit region changes during the resizing processing, and FIGS. 15A to 18B show how the edit region changes during resizing processing in a different mode. Note that each step in FIG. 10 is executed by the processor 111 by reading a program related to the processing in the flowchart from memory and processing the program. The series of processes performed by the poster editing application 131 is the same as the processing in FIG. 2 and is therefore not described in detail here.

As an example, the present embodiment describes a case where the objects 601 to 603 are resized among the objects arranged in the poster edit region 340, as shown in FIG. 11A. Note that the three objects 601 to 603 in the edit region 340 are linked to one another by being aligned vertically based on their respective centers using a vertical center alignment button 351. Once the resizing processing is executed, the plurality of objects 601 to 603 linked to one another by vertical center alignment are resized simultaneously. Note that the plurality of objects 601 to 603 linked to one another are assigned link identification information which is common to these objects and is for uniquely identifying the group generated by the vertical center alignment (positional alignment group).

The processing in FIG. 10 starts upon detection of a user operation for object resizing processing. Here, the resizing processing starts in the event where the pointing device selects a resize handle (not shown) disposed on a rectangular outer frame (not shown) surrounding all the positionally aligned objects, and ends in the event where the selection is cancelled. All the objects belonging to the group are resized in the event where the handle is moved using the pointing device between the start and end of the resizing processing, i.e., during continuance of resizing.

In S1001, the processor 111 detects objects belonging to a positional alignment group selected in the edit region 340. In other words, the processor 111 detects all the objects belonging to the positional alignment group targeted for resizing. For example, in the present embodiment, the objects 601 to 603 in FIG. 11A are detected. Note that this step is not limited to being executed after the detection of an operation for resizing processing and may be executed beforehand.

Next, in S1002, the processor 111 detects an array reference line Lc corresponding to the objects 601 to 603. The array reference line Lc is, as shown in FIG. 11A, a horizontal line connecting the center positions of the rectangular outer frames of the objects 601 to 603 in terms of a direction perpendicular to the array reference line Lc (the vertical direction).

Next, in S1003, for each object, the processor 111 sets a positional alignment point as a reference point. A positional alignment point of an object is a point belonging to the array reference line Lc for positional alignment and being the center position of the rectangular outer frame of the object in a direction along the array reference line Lc (the horizontal direction). Thus, a positional alignment point is a point satisfying the following requirements. A first requirement is that a positional alignment point of an object is fixed at a position bisecting a line segment which bisects a region surrounded by the rectangular outer frame of the object into parts arranged in a direction along the array reference line Lc for positional alignment. Another requirement is that the position of the positional alignment point is adjusted along with the object so as to belong to the array reference line Lc as well. Specifically, for the objects 601 to 603, positional alignment points 601C2, 602C2, and 603C2 are set as their respective resize reference points, as shown in FIG. 11A. Note that a positional alignment point of an object does not have to be fixed at the position bisecting the line segment that bisects a region surrounded by the rectangular outer frame of the object into parts arranged in a direction along the array reference line Lc for positional alignment, as long as it is a point belonging to the object and near the center thereof. For example, a positional alignment point of an object may be a point near a point fixed at the position bisecting the line segment that bisects a region surrounded by the rectangular outer frame of the object into parts arranged in a direction along the array reference line Lc for positional alignment. Also, the bisecting described above does not always necessarily have to mean bisecting into equal parts.

The overall flow of the processing after the execution of S1003 is the same as that after the execution of S503 shown in FIG. 5.

After S1003, the processor 111 iterates the steps between S1004S to S1004E for all the objects in the positional alignment group.

In each iteration, first in S1005, the processor 111 determines whether the object targeted for processing in the current iteration (one of the objects 601 to 603) is inside a prescribed region. In the present embodiment, it is assumed that the poster region 310 is the prescribed region. Note that the prescribed region is not limited to a poster region, and in other examples, may be the trim region 311 or a region surrounded by gridlines serving as guidelines for arrangement.

If the result of the determination in S1005 is YES, i.e., if the region surrounded by the rectangular outer frame of the object is entirely inside the prescribed region, the processor 111 proceeds to S1006. In S1006, the processor 111 executes the resizing processing on the object.

If the result of the determination in S1005 is NO, i.e., if one of the four outer frame lines forming the rectangular outer frame of the object overlaps with one of the four outer-frame lines of the prescribed region, the processor 111 proceeds to the determination processing in S1008. Note that because of the processing in S1009 to be described later, a situation is avoided where part of the region surrounded by the rectangular outer frame of the object lies beyond the prescribed region.

In S1008, the processor 111 determines whether the resize reference point of the object has been changed to a perpendicular point belonging to the outer-frame line of the prescribed region and corresponding to the positional alignment point of the object. A perpendicular point belonging to the outer-frame line of the prescribed region and corresponding to the positional alignment point of the object is a point where a perpendicular drawn from the positional alignment point of the object to the outer-frame line of the prescribe region intersects with the outer-frame line. In other words, in S1008, the processor 111 determines whether changing the reference point during the resizing processing, which is one of the characteristics of the present disclosure, is currently being applied. If the result of the determination in S1008 is NO, i.e., if changing the reference point during the resizing processing is not being currently applied, the processor 111 proceeds to S1009.

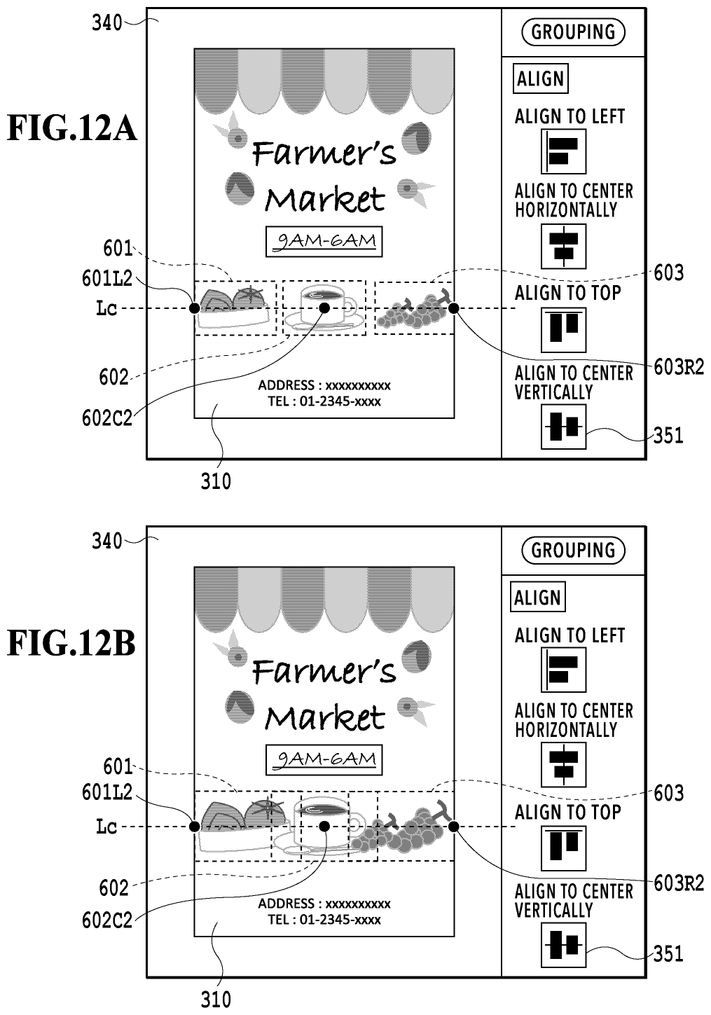

In S1009, the processor 111 changes the resize reference point of the target object to the perpendicular point belonging to the outer-frame line of the prescribed region and corresponding to the positional alignment point of the object. The outer-frame line of the prescribed region here is one of the four outer-frame lines forming the prescribed region which overlaps with an outer-frame line of the object. This perpendicular point also belongs to one of the four outer-frame lines of the object which overlaps with the outer-frame line of the prescribed region. For instance, for the objects 601 and 603, perpendicular points 601L2 and 603R2 are set as new resize reference points, as shown in FIG. 12A.

The processor 111 proceeds from S1009 to S1010 where the processor 111 saves the size that the object had when the reference point was changed in S1009 (i.e., the current size of the object) so that it can be referred to in S1011 to be executed later, and proceeds to S1006.

If the result of the determination in S508 is YES, i.e., if changing the reference point during the resizing processing is currently being applied, the processor 111 proceeds to S1011 where the processor 111 determines whether the current size of the object is the same as the size that the object had when the reference point was changed. In this step, the size of the object saved in S1010 executed last is referred to. If the size of the object is changed after the reference point was changed, the determination in S1011 is NO, but if the size of the object is changed back, the determination in S1011 is YES.

The processor 111 proceeds straight to S1006 if the determination in S1011 is NO. Meanwhile, if it is determined YES in S1011, the processor 111 changes the resize reference point back to the positional alignment point in S1012 and then proceeds to S1006. In other words, after restoring the pre-change reference point in S1012, the processor 111 proceeds to S1006.

After repeating the processing from S1004S to S1004E for every object, the processor 111 determines in S1007 whether the object resizing processing is still being executed. For example, the processing is still being executed in a case where a group resizing operation is continuing. To give a more specific example, the processing is still being executed in a case where, for example, the handle for group resizing is still being selected by the pointing device. If the result of the determination in S1007 is YES, the processor 111 executes the iteration process from S1004S to S1004E again. If the result of the determination in S1007 is NO, the processor 111 ends the resizing processing.

In the example shown in FIG. 11A, link identification information is assigned to the objects 601 to 603. With a scale-up operation, as shown in FIG. 11B, the objects 601 to 603 are scaled up based on their respective positional alignment points 601C2 to 603C2. In the example shown in FIG. 11B, the objects 601 to 603, which are graphics, are scaled up. In the example shown in FIG. 6B, the left frame line of the object 601 overlaps with the left frame line of the prescribed region, and the right frame line of the object 603 overlaps with the right frame line of the prescribed region. In this case, for the objects 601 and 603, the result of the determination in S1005 is NO, and the result of the determination in S1008 is also NO. Thus, in S1009, as shown in FIG. 12A, the resize reference point of the object 601 is changed from the positional alignment point 601C2 to the perpendicular point 601L2, and the resize reference point of the object 603 is changed from the positional alignment point 603C2 to the perpendicular point 603R2. For the object 602, because it is inside the prescribed region, the determination in S1005 is YES, and the positional alignment point 602C2 stays to be its resize reference point.

In a case where an operation for a further size-up is continued on the positional alignment group, the objects 601 to 603 are scaled up as shown in, for example, FIG. 12B. In the example shown in FIG. 12B, compared to the arrangement shown in FIG. 12A, the object 601 is scaled up based on the perpendicular point 601L2, maintaining the horizontal position of the left frame line, and the object 603 is scaled up based on the perpendicular point 603R2, maintaining the horizontal position of the right frame line. Also, the object 602 is scaled up maintaining the position of the positional alignment point 602C2.

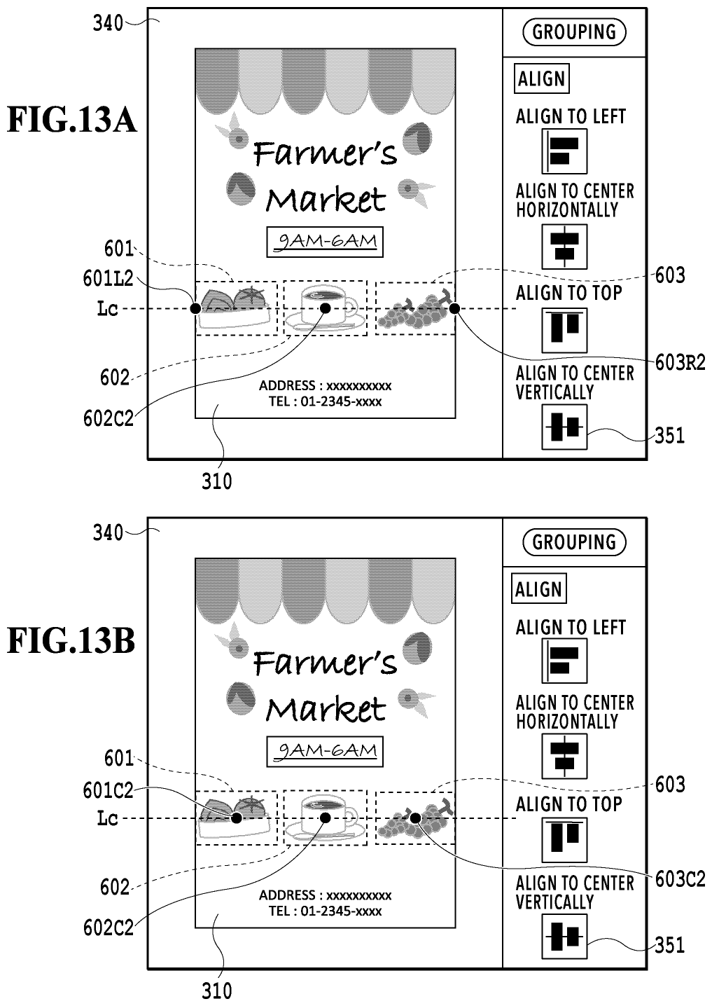

In a case where a size-down operation is performed on the group after that, as shown in FIG. 13A, the objects 601 to 603 may be changed back to the sizes that the objects 601 and 603 had when their respective resize reference points were changed. In this case, for the objects 601 and 603, the determination result in S1005 is NO, the determination result in S1008 is YES, and the determination result in S1011 is YES. Thus, S1012 is executed on the objects 601 and 603, and as shown in FIG. 13B, the resize reference points of the objects 601 and 603 are changed back to the positional alignment points 601C2 and 603C2. Note that the resize reference point of the object 602 is still the positional alignment point 602C2.

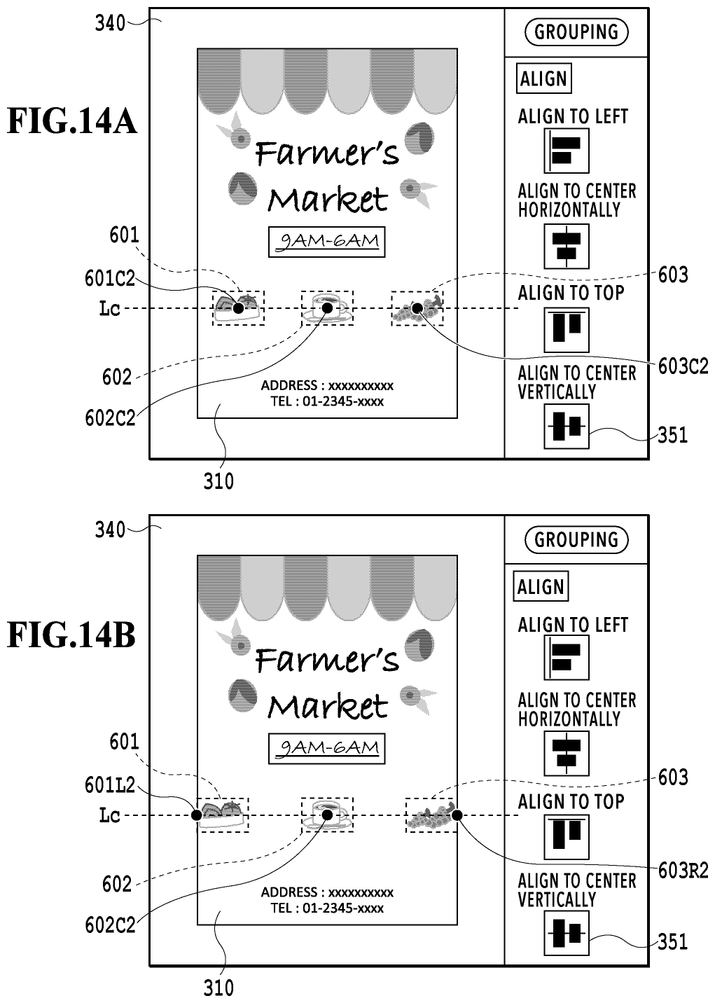

In a case where a size-down operation is further performed on the positional alignment group, the objects 601 to 603 look as shown in FIG. 14A. In the example shown in FIG. 14A, compared to the arrangement shown in FIG. 13B, the objects 601 to 603 are scaled down based on the positional alignment points 601C2 to 603C2, respectively.

In the example described above, in a case where the objects 601 to 603 are resized back to the sizes that the objects 601 and 603 had when their respective resize reference points were changed as shown in FIG. 13A, the resize reference points are changed back as shown in FIG. 13B. However, it is not always needed that the resize reference points are changed back. That is, the resize reference points may be kept in such a case. In a case where a size-down operation is further performed on the group while keeping the changed resize reference points, the objects 601 to 604 look as shown in FIG. 14B. In the example shown in FIG. 14B, compared to the arrangement shown in FIG. 13A, the objects 601 and 603 are scaled down based on the perpendicular points 601L2 and 603R2, respectively. Also, the object 602 is scaled down based on the positional alignment point 602C2.

Although FIGS. 11A to 14B show an example where the objects 601 to 603 are aligned vertically at their respective centers, the present embodiment can also be applied to a case where the objects 601 to 603 are aligned based on different criteria. For example, the present embodiment can be applied to cases where the objects 601 to 603 are aligned at their respective upper edges, at their respective left edges, or at their respective centers horizontally. FIGS. 15A to 18B show an example where the objects 601 to 603 are aligned at their respective upper edges.

In the example shown in FIG. 15A, link identification information is assigned to the objects 601 to 603. Note that an array reference line Lt is, as shown in FIG. 15A, a horizontal line connecting edge positions (upper edge positions) of the rectangular outer frames of the objects 601 to 603 in terms of a direction perpendicular to the array reference line Lt (the vertical direction). With a scale-up operation, as shown in FIG. 15B, the objects 601 to 603 are scaled up based on their respective positional alignment points 601C3 to 603C3. A positional alignment point of an object is a point belonging to the array reference line Lt for positional alignment and located at the center position of the rectangular outer frame of the object in a direction along the array reference line Lt (the horizontal direction). Thus, a positional alignment point is a point satisfying the following requirements. A first requirement is that a positional alignment point of an object is fixed at the upper end of a line segment that bisects a region surrounded by the rectangular outer frame of the object into parts arranged in a direction along the array reference line Lt for positional alignment. Another requirement is that the position of the positional alignment point is adjusted along with the object so as to belong to the array reference line Lt as well.

Note that a positional alignment point of an object does not have to be fixed at the upper end of the line segment that bisects a region surrounded by the rectangular outer frame of the object into parts arranged in a direction along the array reference line Lt for positional alignment, as long as it is a point belonging to the object and near the upper end. For example, a positional alignment point of an object may be near a point fixed at the upper end of the line segment that bisects a region surrounded by the rectangular outer frame of the object into parts arranged in a direction along the array reference line Lt for alignment. Also, the bisecting described above does not always necessarily have to mean bisecting into equal parts.

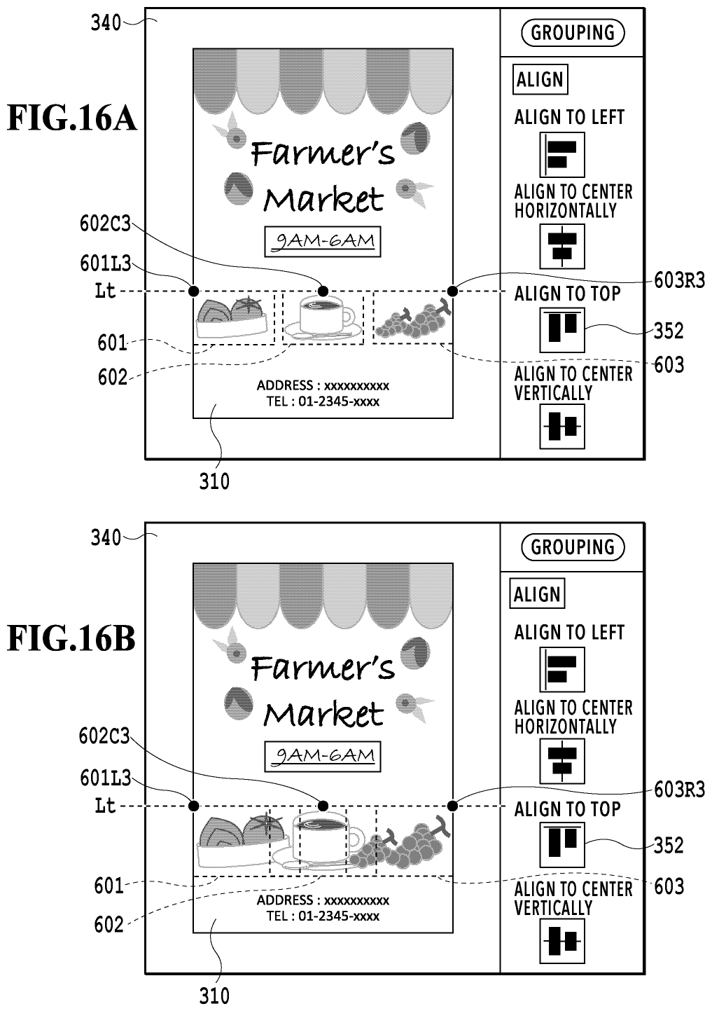

In the example shown in FIG. 15B, the objects 601 to 603, which are graphics, are scaled up. Also, in the example shown in FIG. 15B, the left frame line of the object 601 overlaps with the left frame line of the prescribed region, and the right frame line of the object 603 overlaps with the right frame line of the prescribed region. In this case, for the objects 601 and 603, the result of the determination in S1005 is NO, and the result of the determination in S1008 is also NO. Thus, in S1009, as shown in FIG. 16A, the resize reference point of the object 601 is changed from the positional alignment point 601C3 to a perpendicular point 601L3, and the resize reference point of the object 603 is changed from the positional alignment point 603C3 to a perpendicular point 603R3. The perpendicular point 601L3, which is the reference point after the change, is located at a position where the left frame line and the upper frame line of the object 601 intersect, and the perpendicular point 603R3, which is the reference point after the change, is located at a point where the right frame line and the upper frame line of the object 603 intersect. For the object 602, because it is inside the prescribed region, the determination in S1005 is YES, and the positional alignment point 602C3 stays to be the resize reference point.

In a case where an operation for a further size-up of the positional alignment group is continued, the objects 601 to 603 are scaled up, for example, as shown in FIG. 16B. In the example shown in FIG. 16B, compared to the arrangement shown in FIG. 16A, the object 601 is scaled up based on the perpendicular point 601L3 while maintaining the horizontal position of the left frame line, and the object 603 is scaled up based on the perpendicular point 603R3 while maintaining the position of the right frame line in the horizontal direction. The object 602 is scaled up while maintaining the position of the positional alignment point 602C3.

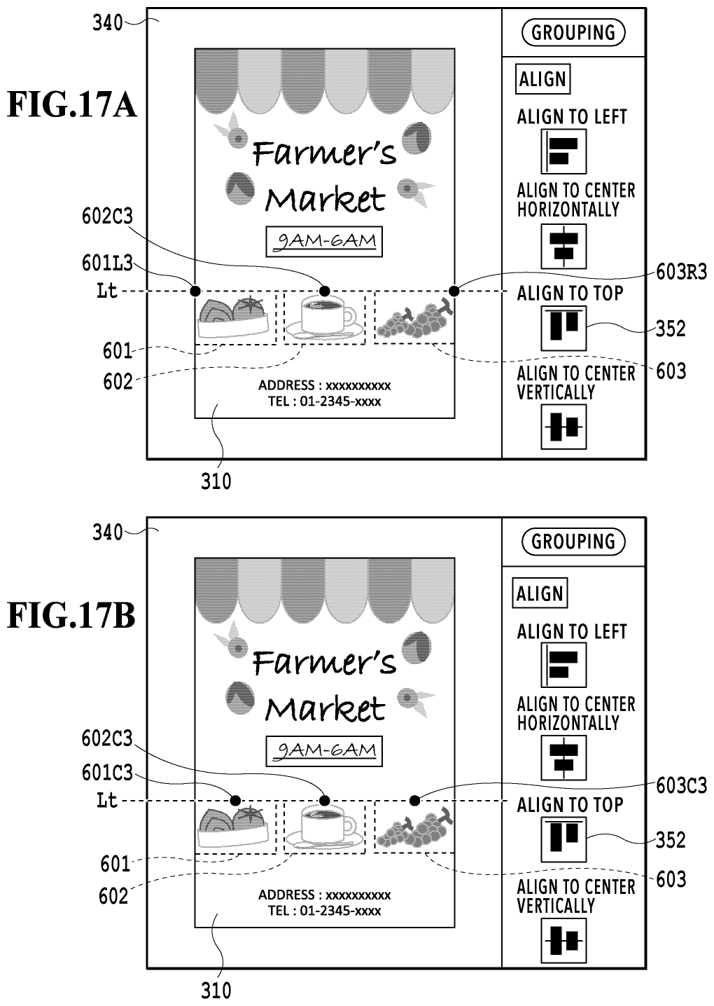

In a case where a size-down operation is performed on the positional alignment group after that, as shown in FIG. 17A, the objects 601 to 603 may be resized back to the sizes that the objects 601 and 603 had when their respective resize reference points were changed. In this case, for the objects 601 and 603, the determination result in S1005 is NO, the determination result in S1008 is YES, and the determination result in S1011 is YES. Thus, S1012 is executed on the objects 601 and 603, and as shown in FIG. 17B, the resize reference points of the objects 601 and 603 are changed back to the positional alignment points 601C3 and 603C3. Note that the resize reference point of the object 602 is still the positional alignment point 602C3.

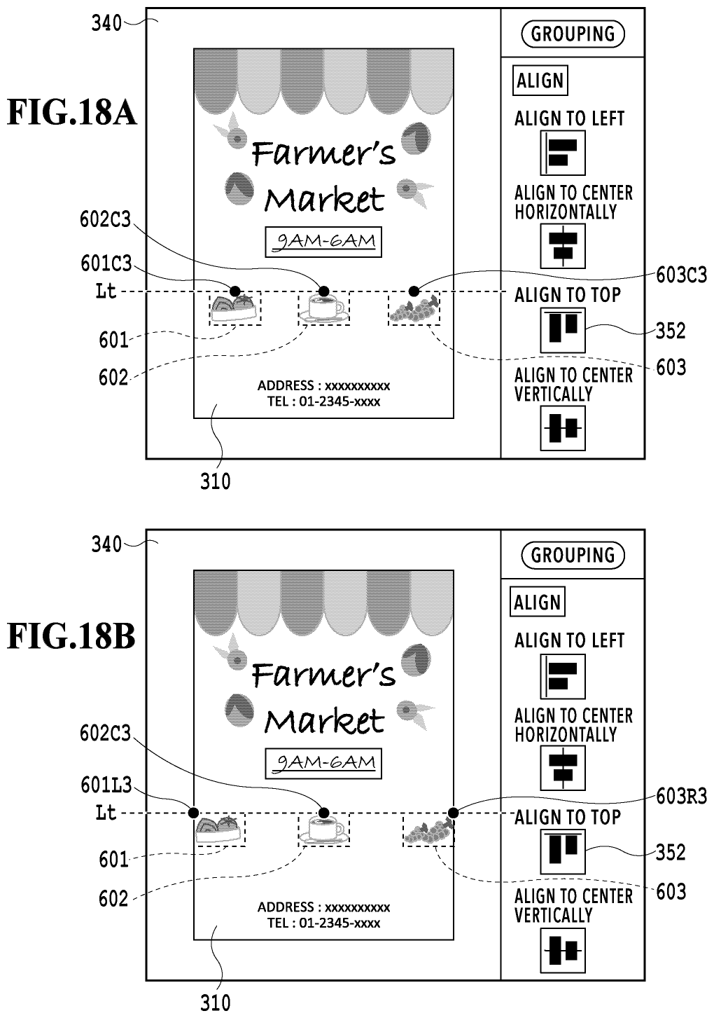

In a case where a size-down operation is further performed on the positional alignment group, the objects 601 to 603 look as shown in FIG. 18A. In the example shown in FIG. 18A, compared to the arrangement shown in FIG. 17B, the objects 601 to 603 are scaled down based on the positional alignment points 601C3 to 603C3, respectively.

In the example described above, in a case where the objects 601 to 603 are resized back to the sizes that the objects 601 and 603 had when their respective resize reference points were changed as shown in FIG. 17A, the resize reference points are changed back as shown in FIG. 17B. However, it is not always needed that the resize reference points are changed back. That is, the resize reference points may be kept in such a case. In a case where a size-down operation is further performed on the group while keeping the changed resize reference points, the objects 601 to 604 look as shown in FIG. 18B. In the example shown in FIG. 18B, compared to the arrangement shown in FIG. 17A, the objects 601 and 603 are scaled down based on the perpendicular points 601L3 and 603R3, respectively, and the object 602 is scaled down based on the positional alignment point 602C3.

### Advantageous Effects of the Present Embodiment

As described above, in the present embodiment, in simultaneous resizing of a plurality of objects linked to one another by aligning arrangement, positional alignment points are set as the resize reference points of the objects. A positional alignment point of an object is a point belonging to an array reference line and located at the center position of the rectangular outer frame of the object in a direction along the array reference line. Then, during the resizing processing, the resize reference point is changed according to the layout so that the object may not be placed outside the prescribed region. This makes it possible to improve useability for a user in performing layout operations and also enables the user to easily create a layout with an excellent design without objects being partly or entirely placed outside the prescribed region in printing or displaying a presentation slide.

### Third Embodiment

Next, a third embodiment is described. In the present embodiment, a plurality of objects linked to one another by common link identification information are resized complementarily so as to have certain lengths of empty space between objects adjacent to each other. Note that where appropriate, the following description omits descriptions of the same configurations as those in the above embodiments by using the same reference numerals or the same names as those used in the above embodiments.

### Resizing Control to Have Uniform Empty Spaces Between Related Objects

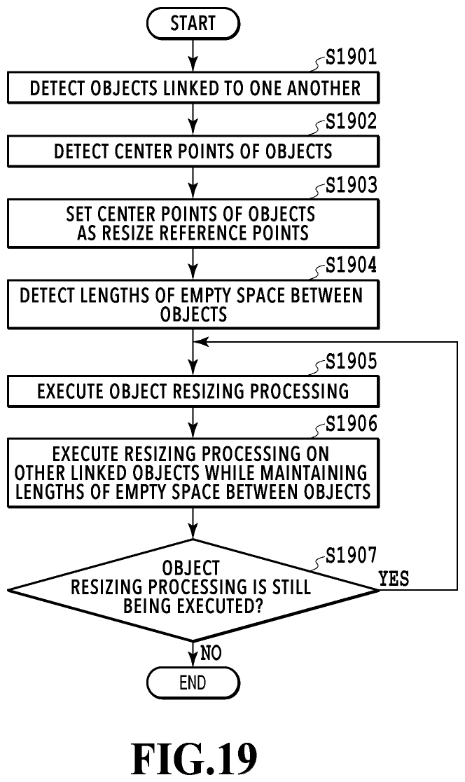

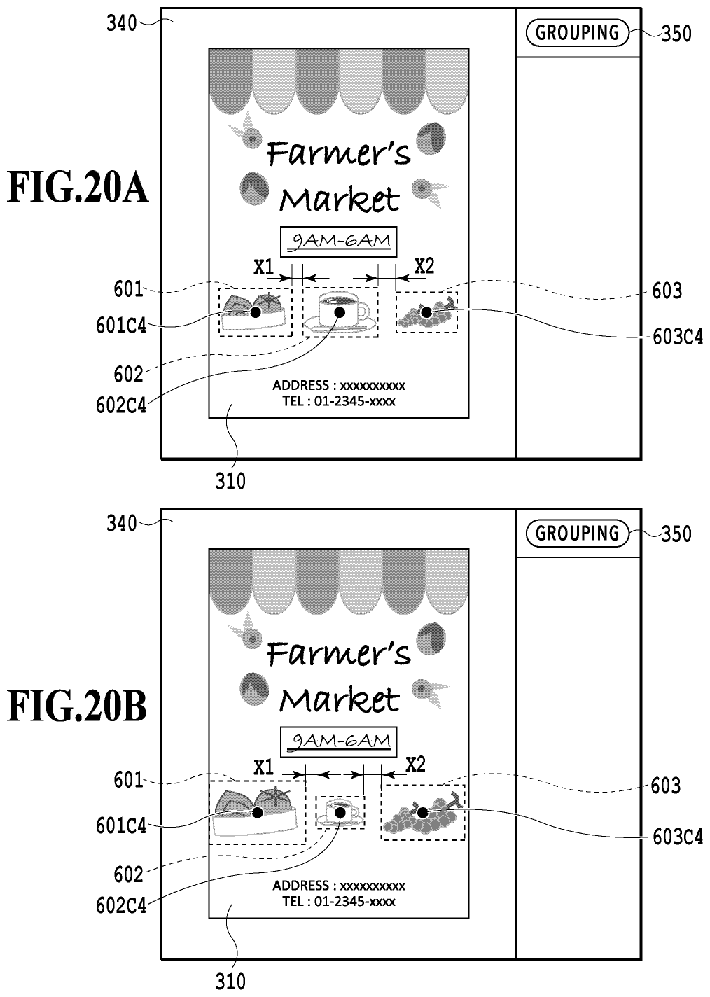

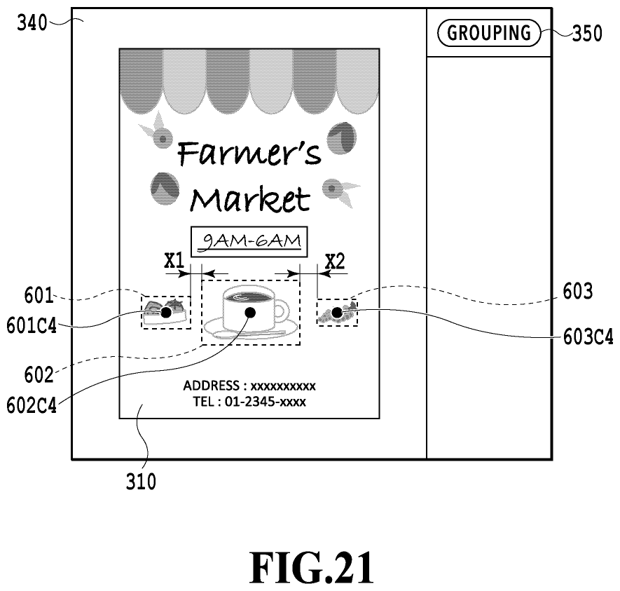

Using FIGS. 19 to 21, the following describes displaying arrangement candidates in the present embodiment. FIG. 19 is a flowchart showing processing of the present embodiment, and FIGS. 20A to 21 show how the edit region changes during the resizing processing. Note that each step in FIG. 19 is executed by the processor 111 by reading a program related to the processing in the flowchart from memory and processing the program. The series of processes performed by the poster editing application 131 is the same as the processing in FIG. 2 and is therefore not described in detail here.

In the present embodiment, as shown in FIG. 20A, the objects 601 to 603 linked to one another are selected from the plurality of objects arranged on the poster edit region 340. Then, the objects 601 to 603 are resized complementarily and simultaneously. Note that the three objects 601 to 603 in the edit region 340 are assigned link identification information beforehand through grouping using the grouping button 350.

The processing in FIG. 19 is started upon detection of a user operation for object resizing processing.

In S1901, the processor 111 detects a plurality of objects linked to one another by grouping in the edit region 340. For example, in the present embodiment, as shown in FIG. 20A, the objects 601 to 603 linked to one another by grouping are detected. Note that this step is not limited to being executed after the detection of an operation for resizing processing and may be executed beforehand.

Next, in S1902, the processor 111 detects center points 601C4 to 603C4 of the respective objects 601 to 603.

Next, in S1903, the processor 111 sets the center points 601C4 to 603C4 of the respective objects 601 to 603 as their respective resize reference points.

Next, in S1904, the processor 111 detects empty spaces between adjacent ones of the objects. In the present embodiment, the length of empty space between the object 601 and the object 602 is detected as X1, and the length of empty space between the object 602 and the object 603 is detected as X2.

In S1905, the processor 111 executes object resizing processing. As an example, the present embodiment describes a case where the object 602 placed at the center in FIG. 20A is resized. In a case where the object 602 is scaled down, the processor 111 executes resizing processing on the object 602 using the object's center point 602C4 as the resize reference point, as shown in FIG. 20B.

Also, in S1906, the processor 111 executes the resizing processing on the other objects assigned the same link identification information as the object 602 while maintaining the lengths of empty space. Specifically, as shown in FIG. 20B, the processor 111 executes the resizing processing such that the objects 601 and 603 are scaled up as the object 602 is scaled down, with the lengths of empty space X1 and X2 being maintained.

Then, in S1907, the processor 111 determines whether the object resizing processing is still being executed. For example, the processing is still being executed in a case where an operation for group resizing is continuing. To give a more specific example, the processing is still being executed in a case where, for example, the handle for group resizing is still being selected by the pointing device. If the result of the determination in this step is YES, i.e., if the user is continuing the object resizing processing, the processor 111 proceeds back to the resizing processing in S1905.

In a case where the object 602 is scaled up, the processor 111 executes resizing processing on the object 602 using the object's center point 602C4 as the resize reference point, as shown in FIG. 21.

Also, in S1906, the processor 111 executes the resizing processing on the other objects assigned the same link identification information as the object 602 while maintaining the lengths of empty space. Specifically, as shown in FIG. 21, the processor 111 executes the resizing processing such that the objects 601 and 603 are scaled down as the object 602 is scaled up, while maintaining the lengths of empty space X1 and X2.

Once the object resizing processing is completed, the processing in the flowchart in FIG. 19 ends. The above is how the series of processes is performed in the present embodiment.

Note that like the first and second embodiments, the present embodiment may determine whether each object is inside the prescribed region and for the object which is not inside the prescribed region, change the reference point thereof during continuance of the resizing processing. For example, the object 601 is scaled up in conjunction with a scale down of the object 602. In a case where the left frame line of the object 601 coincides with the left frame line of the prescribed region, the resize reference point of the object 601 may be changed to a perpendicular point belonging to the left frame line of the prescribed region and corresponding to the center point of the object 601. The same is true for the object 603. Specifically, the object 603 is scaled up in conjunction with the scale down of the object 602. In a case where the right frame line of the object 603 coincides with the right frame line of the prescribed region, the resize reference point of the object 603 may be changed to a perpendicular point belonging to the right frame line of the prescribed region and corresponding to the center point of the object 603. Note that the length of the empty space between the objects is maintained in such a case as well.

In the case described above, the three objects 601 to 603 in the edit region 340 are linked to one another by grouping using the grouping button 350. However, the present disclosure is not limited to this, and complementary resizing similar to the above can be executed also in a case where a plurality of objects are linked to one another by being aligned vertically at their respective centers using the vertical center alignment button 351. Complementary resizing similar to the above can be executed even in a case where a plurality of objects are linked to one another by positional alignment based on different criteria.

From the onset of resizing, the resize reference point of the object 601 may be placed at the center of the left frame line of the object 601, and the resize reference point of the object 603 may be placed at the center of the right frame line of the object 603.

It may be configured such that the object 602 is resized as the object 601 is resized. Further, it may be configured such that the object 603 is resized in conjunction with resizing of the object 602. In other words, as the object 601 is scaled up, the object 602 may be scaled down, and further, the object 603 may be scaled up. Similarly, as the object 601 is scaled down, the object 602 may be scaled up, and further, the object 603 may be scaled down.

Similarly, it may be configured such that as the object 603 is resized, the object 602 is also resized. Further, it may be configured such that the object 601 is also resized in conjunction with the resizing of the object 602.

### Advantageous Effects of the Present Embodiment

As described, in the present embodiment, in simultaneous resizing of a plurality objects linked to one another, the center point of each object is set as its initial reference point used during the object's resizing processing. Then, the objects are resized complementarily with the lengths of empty space between the objects being maintained. This makes it possible to improve usability for a user in performing layout operations and also enables the user to easily create a layout with an excellent design with consistent lengths of empty space.

### Fourth Embodiment

Next, a fourth embodiment is described. The present embodiment is the same as the first embodiment except that the number of the objects to resize is one. Thus, in the present embodiment, link information is omitted unlike the above embodiments. One object is targeted by resizing processing. Note that where appropriate, the following description omits descriptions of the same configurations as those in the first embodiment by using the same reference numerals or the same names as those used in the first embodiment.

### Changing the Reference Point During Resizing Processing According to the Layout

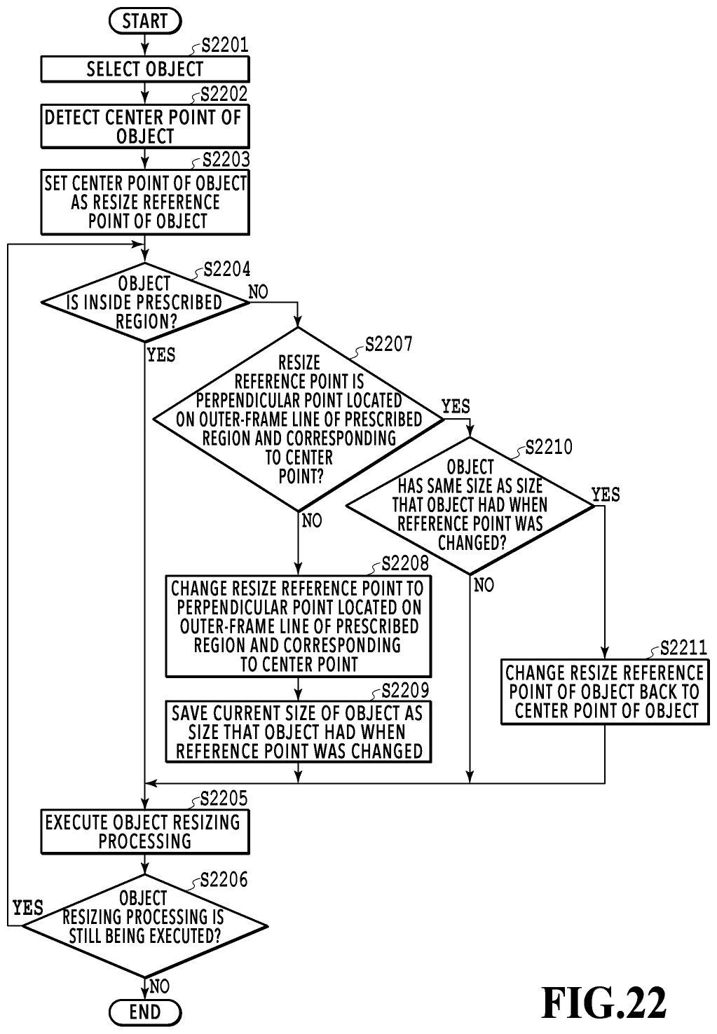

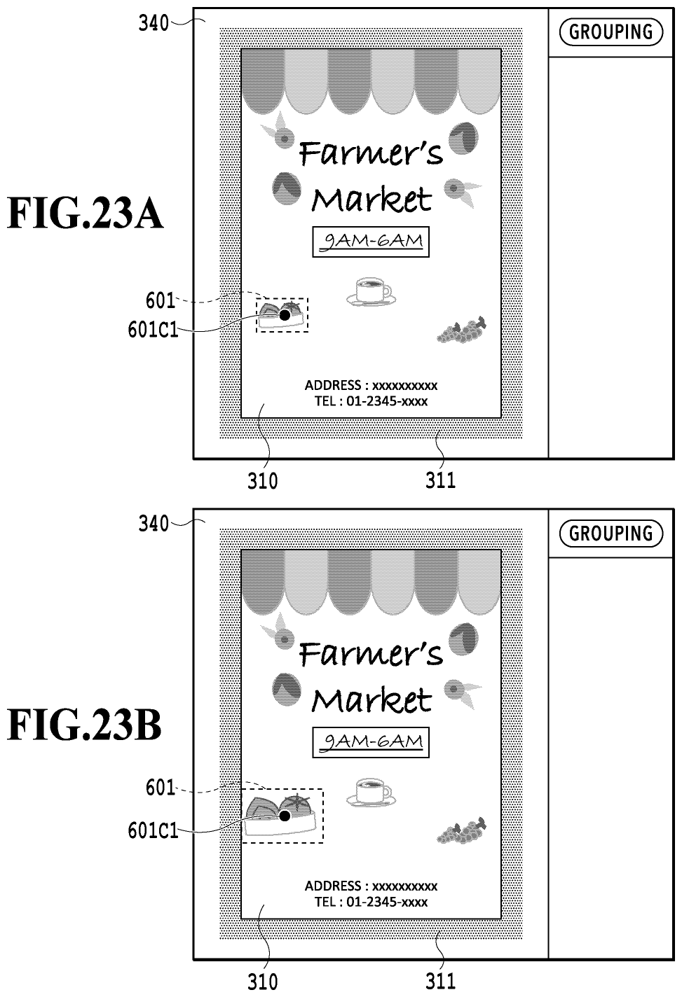

Using FIGS. 22 to 26B, the following describes displaying arrangement candidates in the present embodiment. FIG. 22 is a flowchart showing processing of the present embodiment, and FIGS. 23A to 26B show how the edit region changes during the resizing processing. Note that each step in FIG. 22 is executed by the processor 111 by reading a program related to the processing in the flowchart from memory and processing the program. The series of processes performed by the poster editing application 131 is the same as the processing in FIG. 2 and is therefore not described in detail here.

As an example, the present embodiment describes a case where the object 601 is resized among the objects arranged in the poster edit region 340, as shown in FIG. 23A.

The processing in FIG. 22 starts upon detection of a user operation for object resizing processing. Here, the resizing processing starts in the event where the pointing device selects a resize handle (not shown) disposed on a rectangular outer frame (not shown) of the object, and ends in the event where the selection is cancelled. The object is resized in the event where the handle is moved using the pointing device during continuance of resizing.

In S2201, the processor 111 detects the object which is being selected in the edit region 340. For example, in the present embodiment, the object 601 in FIG. 23A is detected. Note that this step is not limited to being executed after the detection of an operation for resizing processing and may be executed beforehand.

Next, in S2202, the processor 111 detects the center point of the object 601. The center point of the object 601 is detected as a center point 601C5, as shown in FIG. 23A. The center point of the object 601 is, for example, the center point of the rectangular outer frame of the object 601, as shown in FIG. 23A.

Next, in S2203, the processor 111 sets the center point of the object 601 as the resize reference point. Specifically, as shown in FIG. 23A, for the object 601, the object's center point 601C5 is set as the resize reference point.

Next, in S2204, the processor 111 determines whether the object 601 is inside the prescribed region. In the description of the present embodiment, it is assumed that the prescribed region is the poster region 310. Note that the prescribed region is not limited to the poster region, and in other examples, may be the trim region 311 or a region surrounded by gridlines serving as guidelines for arrangement.

S2204, S2205, and S2207 to S2211 are the same as S505, S506, and S508 to S512 as shown in FIG. 5 and are not described here to avoid repetition.

After executing S2205, in S2206, the processor 111 determines whether the object resizing processing is still being executed. For example, the processing is still being executed in a case where an operation for resizing is continuing. To give a more specific example, the processing is still being executed in a case where, for example, the handle for resizing the object 601 is still being selected by the pointing device. If the result of the determination in S2206 is YES, the processor 111 proceeds back to S2204. Meanwhile, if the result of the determination in S2206 is NO, the processor 111 ends the resizing processing.

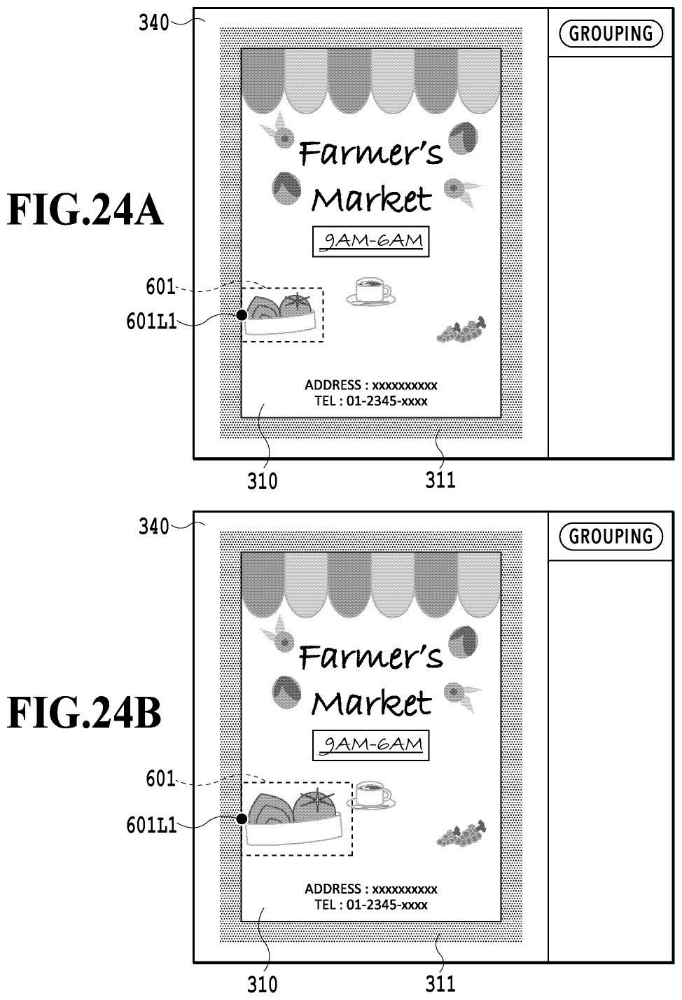

Once a scale-up operation is performed, the object 601 is scaled up based on the center point 601C5, as shown in FIG. 23B. In the example shown in FIG. 23B, the object 601, which is a graphic, is scaled up. In the example shown in FIG. 23B, the left frame line of the object 601 overlaps with the left frame line of the prescribed region. In this case, the result of the determination in S2204 is NO, and the result of the determination in S2207 is also NO. Thus, in S2208, the resize reference point of the object 601 is changed from the center point 601C5 to a perpendicular point 601L5 as shown in FIG. 24A.

In a case where the operation for a further size-up is continued on the object 601, the object 601 is scaled up for example as shown in FIG. 24B. In the example shown in FIG. 24B, compared to the arrangement shown in FIG. 24A, the object 601 is scaled up based on the perpendicular point 601L5 while maintaining the horizontal position of the left frame line.

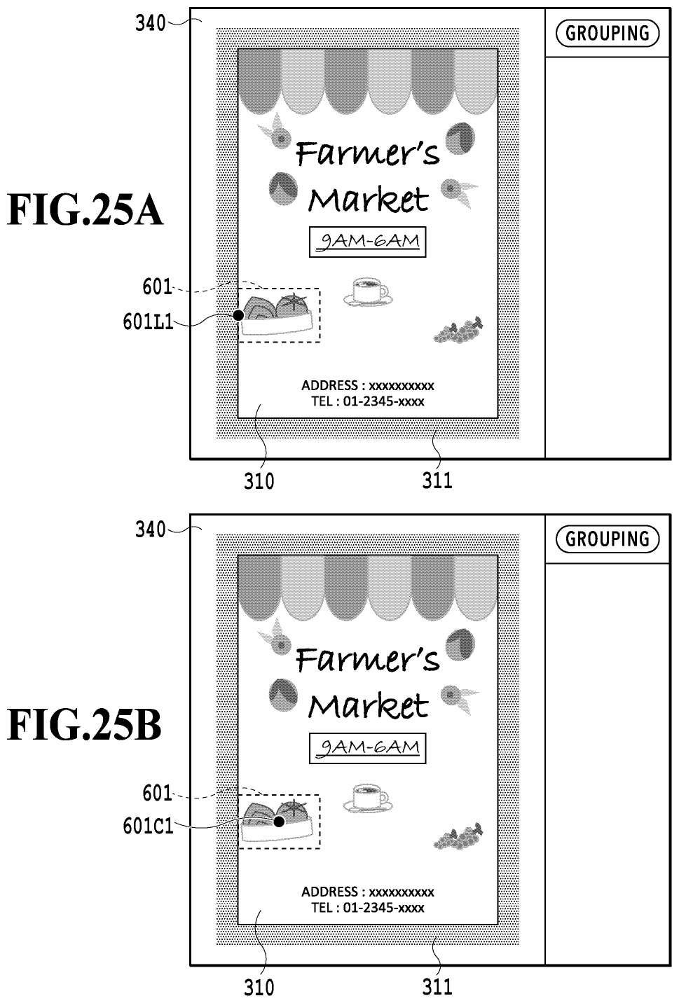

In a case where a size-down operation is performed on the object 601 after that, as shown in FIG. 25A, the object 601 may be changed back to the size that the object 601 had when its resize reference point was changed. In this case, the determination result in S2204 is NO, the determination result in S2207 is YES, and the determination result in S2210 is YES. Thus, S2211 is executed on the object 601, and as shown in FIG. 25B, the resize reference point of the object 601 is changed back to the center point 601C5.

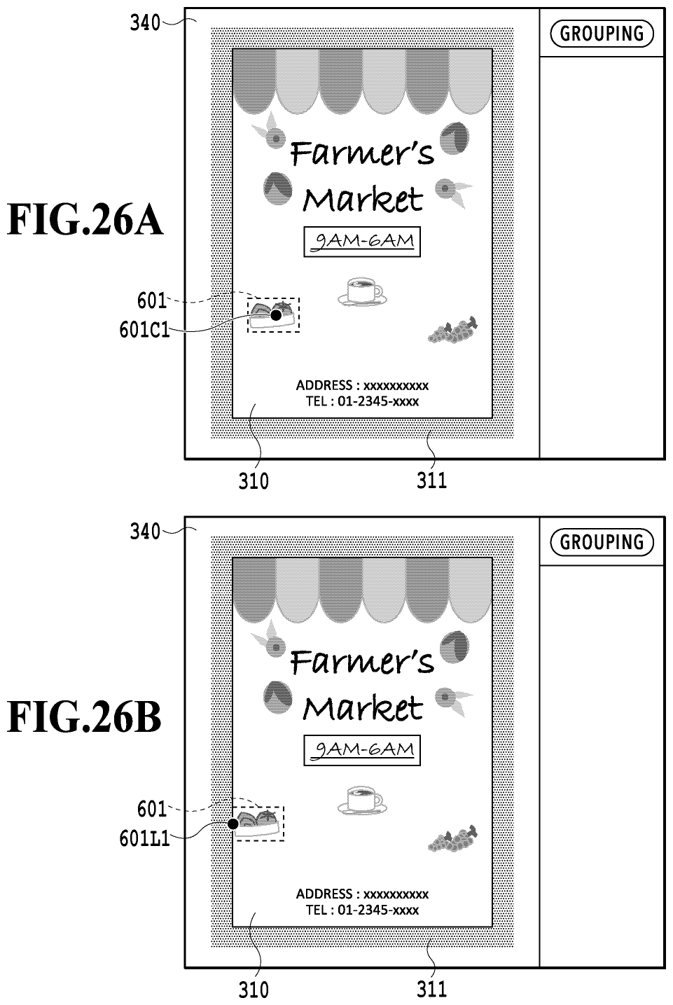

In a case where a size-down operation is further performed on the object 601, the object 601 looks as shown in FIG. 26A. In the example shown in FIG. 26A, compared to the arrangement shown in FIG. 25B, the object 601 is scaled down based on the center point 601C5.

In the example described above, in a case where the object 601 is resized back to the size that the object 601 had when its resize reference point was changed as shown in FIG. 25A, the resize reference point is changed back as shown in FIG. 25B. However, it is not always needed that the resize reference point is changed back. That is, the resize reference point may be kept in such a case. In a case where a size-down operation is further performed on the group while keeping the changed resize reference point, the object 601 looks as shown in FIG. 26B. In such a case, in a case where a size-down operation is further performed on the object 601, the arrangement of the object 601 looks as shown in FIG. 26B. In the example shown in FIG. 26B, compared to the arrangement shown in FIG. 25A, the object 601 is scaled down based on the perpendicular point 601L5.

### Advantageous Effects of the Present Embodiment

As described above, in the present embodiment, in resizing of a single object, the center point of the object is set as the resize reference point of the object. Then, the resize reference point is changed according to the layout so that the object will not be placed outside the prescribed region. This makes it possible to improve useability for a user in performing layout operations and also enables the user to easily create a layout with an excellent design without objects being partly or entirely placed outside the prescribed region in printing or displaying a presentation slide.

### Other Embodiments

The poster editing application 131 may have some or all of the functions of the four embodiments described above.

Also, although the poster editing application 131 is used to execute the processing in the embodiments described above, the application to which the concept of the present disclosure can be applied is not limited to a poster editing application. For example, the concept of the present disclosure can be applied to all kinds of layout software for adding and placing object data, such as a layout editing application, an album editing application, and presentation creation software.

An operation for selecting or moving a handle using a pointing device does not always necessarily have to be done by a user. For example, it may be performed by execution of a program by a computer or may be performed in accordance with inputs from a different apparatus or device. The handle may be selected or moved using a device other than a pointing device (e.g., a keyboard). In this case as well, the operation does not always necessarily have to be performed by a user, and for example, it may be performed by execution of a program by a computer or may be performed in accordance with inputs from a different apparatus or device. Thus, a user interface does not always necessarily have to be used for selecting a group, resizing, and the like.

Image data such as poster data does not always necessarily have to be displayed on a monitor. For example, in a case where resize scales and resize rules are given, image data after object resize can be generated by reading image data and performing computation processing thereon. Computation processing for changing or changing back the resize reference point can be added as well.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-008041, filed on Jan. 23, 2023, which is hereby incorporated by reference wherein in its entirety.

What is claimed is:

1. A non-transitory computer readable storage medium on which a computer program is recorded, the computer program, when executed, causing a computer to perform an object resizing method comprising:
receiving an input for simultaneously changing sizes of a plurality of objects linked to one another in an edit region on a screen and
changing the sizes of the plurality of objects simultaneously in response to the input while changing the sizes of the plurality of objects based on reference points provided to the respective objects.

2. The non-transitory computer readable storage medium according to claim 1, wherein
the plurality of objects are linked to one another by grouping of the plurality of objects.

3. The non-transitory computer readable storage medium according to claim 1, wherein
the reference points are center points of the respective objects.

4. The non-transitory computer readable storage medium according to claim 1, wherein
the plurality of objects are linked to one another by positional alignment of the plurality of objects.

5. The non-transitory computer readable storage medium according to claim 4, wherein
the reference points are each a point belonging to a corresponding one of the objects, the point being adjusted in position along with the corresponding object so as to belong to an array reference line for positional alignment of the plurality of objects as well.

6. The non-transitory computer readable storage medium according to claim 1, wherein
in the changing the sizes, the plurality of objects are scaled up or down simultaneously.

7. The non-transitory computer readable storage medium according to claim 1, wherein
in the changing the sizes,
in scaling up of a first object included in the plurality of objects, a certain length of empty space is maintained between the first object and a second object adjacent to the first object by scaling down of the second object, and
in scaling down of the first object included in the plurality of objects, a certain length of empty space is maintained between the first object and the second object adjacent to the first object by scaling up of the second object.

8. The non-transitory computer readable storage medium according to claim 1, wherein
the object resizing method further comprises, in a case where a frame line of a certain one of the objects overlaps with a frame line of a prescribed region during continuation of the changing the sizes of the plurality of objects, changing the reference point of the certain object to a perpendicular point, the perpendicular point belonging to the frame line of the prescribed region with which the frame line of the object overlaps, and the perpendicular point corresponding to the reference point.

9. The non-transitory computer readable storage medium according to claim 8, wherein
the object resizing method further comprises, in a case where a certain one of the objects the reference point of which has been changed in the changing the reference point is resized back to the size that the certain object had when the changing the reference point was executed, changing the reference point of the certain object back to the reference point before the changing of the reference point.

10. An information processing apparatus comprising:
an input unit configured to receive an input for simultaneously changing sizes of a plurality of objects linked to one another in an edit region on a screen; and
a resizing unit configured to change the sizes of the plurality of objects simultaneously in response to the input while changing the sizes of the plurality of objects based on reference points provided to the respective objects.

11. An object resizing method comprising:
receiving an input for simultaneously changing sizes of a plurality of objects linked to one another in an edit region on a screen; and
changing the sizes of the plurality of objects simultaneously in response to the input while changing the sizes of the plurality of objects based on reference points provided to the respective objects.
